(19) United States
(12) Patent Application Publication
(10) Pub. No.: US 2023/0128721 A1
(43) Pub. Date: Apr. 27, 2023

(54) CUSTOM VIDEO WORKOUT PROGRAMS FOR EXECUTION ON AN EXERCISE MACHINE

(71) Applicant: iFIT Inc., Logan, UT (US)

(72) Inventor: Robert Plummer, Logan, UT (US)

(73) Assignee: iFIT Inc., Logan, UT (US)

(21) Appl. No.: 17/742,871

(22) Filed: May 12, 2022

Related U.S. Application Data
(60) Provisional application No. 63/188,431, filed on May 13, 2021.

(51) Int. Cl. A63B 24/00; A63B 71/06; G06V 20/40; H04N 21/234

(52) U.S. Cl. CPC A63B 24/0075; A63B 24/0062; A63B 71/0622; G06V 20/49; H04N 21/23424

(57) ABSTRACT

In one aspect of the disclosure, a method to generate a custom video workout program for a user may include dividing each of multiple video workout programs into multiple segments, selecting a subset of the segments for inclusion in a custom video workout program for a user based on one or more user criteria specific to the user, the subset including at least a first segment from a first video workout program and a second segment from a second video workout program, and splicing the subset of segments together to generate the custom video workout program for the user.

### CROSS REFERENCE TO RELATED APPLICATION

This application claims the benefit of and priority to U.S. Provisional Patent Application No. 63/188,431, filed May 13, 2021, which is incorporated herein by reference in its entirety for all that it discloses.

### BACKGROUND

Stationary exercise machines have become an increasingly popular way to exercise. To combat the boredom and burnout that is often experienced by users that exercise with these exercise machines, exercise machines are often sold with a number of different pre-programmed workout programs that are saved within the electronics of the exercise machines. For example, these workout programs may include a “fat burn” workout program, a “hills” workout program, a “performance” workout program, and/or other workout programs.

To enable a user to become more immersed in a workout performed on an exercise machine, some exercise machines are capable of executing video workout programs. A video workout program generally includes a video that depicts a trainer performing a workout to allow one or more users to mimic the workout. For example, where a trainer is running at 6 miles per hour in a video of a video workout program, each of the users may control the running belts of their respective treadmills to likewise operate at 6 miles per hour.

Video workout programs can improve users' workout experiences. Many video workout programs enjoyed by users include video of trainers performing workouts, such as running or biking, in different locations throughout the world. However, such video workout programs may require a significant amount of time and cost to produce which may limit a total number of video workout programs that may be available to users.

The subject matter claimed herein is not limited to embodiments that solve any disadvantages or that operate only in environments such as those described above. Rather, this background is only provided to illustrate one example technology area where some embodiments described herein may be practiced.

### SUMMARY

In one aspect of the disclosure, method to generate a custom video workout program for a user may include dividing each of multiple video workout programs into multiple segments; selecting a subset of the segments for inclusion in a custom video workout program for a user based on one or more user criteria specific to the user, the subset including at least a first segment from a first video workout program and a second segment from a second video workout program; and splicing the subset of segments together to generate the custom video workout program for the user.

Another aspect of the disclosure may include any combination of the above-mentioned features and may further include the one or more user criteria include at least one of: interests of the user, needs of the user, exercise machines the user has access to, scenery preferences of the user, goals of the user, educational content preferences of the user, or trainer preferences of the user.

Another aspect of the disclosure may include any combination of the above-mentioned features and may further include the selecting of the subset of segments is further based on at least one of an excitement parameter of each of the segments, a fun parameter of each of the segments, and/or an enjoyment parameter of each of the segments.

Another aspect of the disclosure may include any combination of the above-mentioned features and may further include the first video workout program is executable on a first type of exercise machine; the second video workout program is executable on a second type of exercise machine that is different than the first type of exercise machine; the custom video workout program includes segments that are executable on different types of exercise machines, including the first segment that is executable on the first type of exercise machine and the second segment that is executable on the second type of exercise machine.

Another aspect of the disclosure may include any combination of the above-mentioned features and may further include executing the custom video workout program at one or more exercise machines to enable the user to perform a custom workout.

Another aspect of the disclosure may include any combination of the above-mentioned features and may further include the selecting of the subset of segments includes dynamically selecting one or more subsequent segments of the subset after execution at the one or more exercise machines of at least a portion of a prior segment of the subset.

Another aspect of the disclosure may include any combination of the above-mentioned features and may further include the dynamically selecting includes dynamically selecting the second segment after execution of at least a portion of the first segment at the one or more exercise machines.

Another aspect of the disclosure may include any combination of the above-mentioned features and may further include monitoring, at the one or more exercise machines, one or more performance parameters of the user during execution of the prior segment of the subset, and the dynamically selecting of the one or more subsequent segments of the subset is further based on the one or more performance parameters of the user.

Another aspect of the disclosure may include any combination of the above-mentioned features and may further include prior to the selecting of the subset of segments, determining the one or more user criteria, including: presenting one or more survey questions to the user before, during, or after execution of a video workout program at an exercise machine; and receiving one or more responses to the one or more survey questions from the user.

Another aspect of the disclosure may include any combination of the above-mentioned features and may further include a non-transitory computer-readable medium having computer-executable instructions stored thereon that are executable by a processing unit to perform or control performance of any combination of the above-mentioned features.

Another aspect of the disclosure may include any combination of the above-mentioned features and may further include, or may stand alone by including, a method to generate a custom series of video workout programs for a user. The method may include determining one or more user criteria specific to a user; identifying, based on the one or more user criteria, a subset of video workout programs in a video workout program library that match the user criteria; and assembling the subset of video workout programs into a custom series of video workout programs for the user to be executed at one or more exercise machines for the user over a period of time.

Another aspect of the disclosure may include any combination of the above-mentioned features and may further include the determining of the one or more user criteria includes: presenting one or more survey questions to the user before, during, or after execution of a video workout program at an exercise machine; and receiving one or more responses to the one or more survey questions from the user.

Another aspect of the disclosure may include any combination of the above-mentioned features and may further include each of the one or more survey questions relates to at least one of: a level of engagement of the user with the video workout program; a level of enjoyment of the user of the video workout program; one or more types of exercise machines the user desires to use more for video workout programs in the future; one or more types of exercise machines the user desires to use less for video workout programs in the future; one or more fitness goals of the user; or a typical amount of sleep of the user.

Another aspect of the disclosure may include any combination of the above-mentioned features and may further include the presenting of the one or more survey questions to the user includes presenting the one or more survey questions to the user aurally, visually, or both aurally and visually.

Another aspect of the disclosure may include any combination of the above-mentioned features and may further include providing access to the one or more user criteria to a trainer and receiving input from the trainer and the identifying of the subset of video workout programs based on the one or more user criteria includes identifying the subset of video workout programs based on the input from the trainer.

Another aspect of the disclosure may include any combination of the above-mentioned features and may further include presenting educational content to the user at an output device included, in or communicatively coupled to, a given exercise machine of the one or more exercise machines during execution of a given video workout program of the one or more video workout programs at the given exercise machine.

Another aspect of the disclosure may include any combination of the above-mentioned features and may further include presenting, through the output device, one or more questions to the user that are related to the educational content.

Another aspect of the disclosure may include any combination of the above-mentioned features and may further include monitoring, at the given exercise machine, a performance parameter of the user during execution of the given video workout program at the given exercise machine, and a difficulty of the one or more questions presented to the user at any given time depending on at least one of the performance parameter at the given time or a difficulty of the given video workout program at the given time.

Another aspect of the disclosure may include any combination of the above-mentioned features and may further include the one or more user criteria including one or more fitness goals of the user and the subset of video workout programs that match the user criteria including video workout programs to assist the user in achieving the one or more fitness goals.

Another aspect of the disclosure may include any combination of the above-mentioned features and may further include a non-transitory computer-readable medium having computer-executable instructions stored thereon that are executable by a processing unit to perform or control performance of any combination of the above-mentioned features.

Another aspect of the disclosure may include any combination of the above-mentioned features and may further include, or may stand alone by including, a method to generate a custom video workout program. The method may include recording a video of a trainer performing a workout; dividing the video into multiple video segments; generating multiple video workout programs from the video segments, each video workout program including a warmup, a different one of the video segments, and a cooldown; receiving input to combine two or more of the video workout programs into the custom video workout program; and in response to the input, splicing together video segments of the two or more of the video workout programs into the custom video workout program, without any intervening warmups or cooldowns between a first one of the video segments of the two or more of the video workout programs and a last one of the video segments of the two or more of the video workout programs.

Another aspect of the disclosure may include any combination of the above-mentioned features and may further include the video workout programs include first and second video workout programs; the first video workout program includes a first video segment preceded by a first warmup and followed by a first cooldown; the second video workout program includes a second video segment preceded by a second warmup and followed by a second cooldown; the input to combine the two or more of the video workout programs into the custom video workout program includes input to append the second video workout program to the first video workout program; executing the first video workout program at an exercise machine to enable a user to perform a portion of the workout; and terminating execution of the first video workout program at or prior to the first cooldown and initiating execution of the second video workout program at an end of or following the second warmup to splice the first video segment and the second video segment together.

Another aspect of the disclosure may include any combination of the above-mentioned features and may further include a non-transitory computer-readable medium having computer-executable instructions stored thereon that are executable by a processing unit to perform or control performance of any combination of the above-mentioned features.

It is to be understood that both the foregoing summary and the following detailed description are explanatory and are not restrictive of the invention as claimed.

### BRIEF DESCRIPTION OF THE DRAWINGS

Embodiments will be described and explained with additional specificity and detail through the use of the accompanying drawings in which:

FIG. 1 illustrates a flowchart of an example exercise machine system;

FIG. 2 illustrates a block diagram of an example exercise machine;

FIG. 3 is a block diagram of example video workout programs and custom video workout programs;

FIG. 4A is a screenshot of an example user interface (UI) of an interactive fitness platform that may be used to collect user criteria from an online fitness profile of a user for customizing video workout programs;

FIG. 4B is a screenshot of an example UI that may be presented to a user in response to selection of an option included in the UI of FIG. 4A;

FIG. 4C is a screenshot of the UI of FIG. 4B with a drop-down menu that may be presented to the user;

FIGS. 5A-5C illustrate video frames of a custom video workout program that may be generated as described herein;

FIG. 6 illustrates a flowchart of an example method to generate a custom video workout program for a user;

FIG. 7 is a block diagram of an example method of generating a custom series of video workout programs for a user from video workout programs based on user criteria;

FIGS. 8A and 8B include screenshots of example UIs that may be used to collect user criteria from a user for generating custom series of video workout programs;

FIG. 9 illustrates a flowchart of an example method to generate a custom series of video workout programs for a user;

FIG. 10 is a block diagram of an example method to generate custom video workout programs;

FIG. 11 includes a screenshot of an example UI to generate a custom video workout program;

FIG. 12 illustrates a flowchart of another example method to generate a custom video workout program for a user; and

FIG. 13 illustrates an example computer system that may be employed in performing or controlling performance of one or more of the methods or actions herein.

Throughout the drawings, identical reference numbers designate similar, but not necessarily identical, elements.

### DETAILED DESCRIPTION

Users may grow bored and/or complacent when they repeat the same video workout program. Time, cost, and/or other factors may limit a total number of video workout programs that may be available to users. Embodiments herein may split existing video workout programs into segments and combine the segments in new combinations to generate custom video workout programs. While the segments themselves may not be new, each new combination of segments may feel like a new video workout program to users which may reduce the boredom and/or complacency that users otherwise experience when repeating the same video workout program. The segments may have various attributes and may be combined based on user criteria. For example, if a user prefers a certain trainer among various trainers featured in video workout programs, segments that feature the preferred trainer may be selected for inclusion in custom video workout programs for the user.

Some embodiments may alternatively or additionally generate custom series of video workout programs. The determination of video workout programs to include in each custom series may depend on user criteria such as user fitness goals. In some examples, the user criteria may be determined by presenting a survey to the user which may include one or more survey questions that relate to, among potentially other things, the user's fitness goals.

Alternatively or additionally, some embodiments may combine multiple separate video workout programs together as a custom video workout program. For example, video of long events, such as marathons, century rides, or other long events, may be divided into video segments, each of which may be used to generate video workout programs that cover the event in segments. Each of these video workout programs individually may be more manageable to many users than a single video workout program that covers the entire event. Even so, some users may prefer, at least occasionally, to experience multiple segments of the event together. Accordingly, some embodiments permit users to combine multiple video workout programs together as a custom video workout program. In these and other embodiments, all warmups and cooldowns of all video workout programs to be combined in the custom video workout program may be omitted except for a warmup of the first video workout program and a cooldown of the last video workout program.

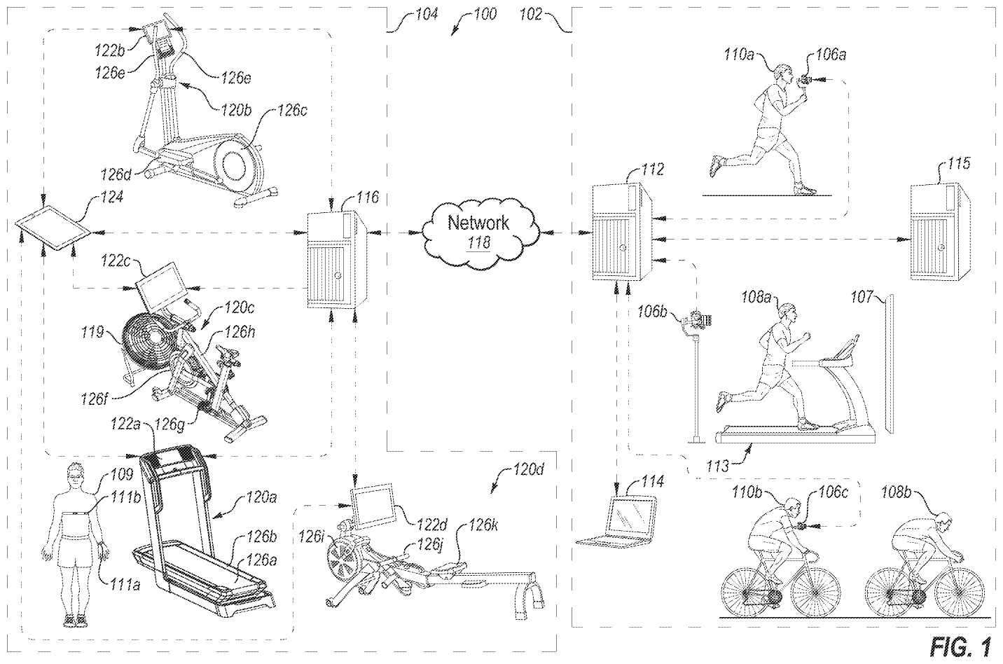

Turning now to the drawings, FIG. 1 illustrates a flowchart of an example exercise machine system 100. The exercise machine system 100 may include a remote location 102 and a local location 104 connected by a network 118.

In some embodiments, the network 118 may be configured to communicatively couple any two devices in the exercise machine system 100 to one another, and/or to other devices. In some embodiments, the network 118 may be any wired or wireless network, or combination of multiple networks, configured to send and receive communications between systems and devices. In some embodiments, the network 118 may include a Personal Area Network (PAN), a Local Area Network (LAN), a Metropolitan Area Network (MAN), a Wide Area Network (WAN), a Storage Area Network (SAN), the Internet, or some combination thereof. In some embodiments, the network 118 may also be coupled to, or may include, portions of a telecommunications network, including telephone lines, for sending data in a variety of different communication protocols, such as a cellular network or a Voice over IP (VoIP) network.

In the remote location 102, the exercise machine system 100 may include one or more video cameras 106a, 106b, 106c (hereinafter collectively “video cameras 106” or generically “video camera 106”) that may be employed to capture video for use in a video workout program as described herein. One or more of the video cameras 106 may include stabilization capabilities to avoid the captured video from being unduly shaky. One or more of the video cameras 106 may be operated by a videographer 110a, 110b (hereinafter collectively “videographers 110” or generically “videographer 110”). Although a videographer 110 is not shown in connection with the video camera 106b in FIG. 1, in other embodiments the video camera 106b may be operated by a videographer.

Some video, such as the video captured by the video cameras 106b, 106c, may include a trainer 108a, 108b (hereinafter collectively “trainers 108” or generically “trainer 108”) performing a workout. In an embodiment, a trainer may perform a workout on location and a videographer may capture video of the trainer as the trainer performs the workout on location. For example, the videographer 110b may use the video camera 106c to capture video of the trainer 108b performing a workout in which the trainer 108b rides a bicycle in a live road bicycle race. In another embodiment, a trainer may perform a workout on a set or stage in front of one or more chroma key screens or display panels and the video of the trainer performing or directing the workout may be combined with an image or video of a scene or moving through an environment using chroma keying or other suitable technology. For example, a videographer 110 may use the video camera 106b to capture video of the trainer 108a performing a workout on an exercise machine 113 in front of one or more chroma key screens or display panels 107, hereinafter “backdrop 107”. The video of the trainer 108a may be combined with an image or video, referred to as a background image or video, e.g., by a chroma key process where the backdrop 107 includes one or more chroma key screens or by displaying the background image or video on the backdrop 107 while the video of the trainer 108a is captured where the backdrop 107 includes one or more display panels. The exercise machine system 100 may include a remote server 112 that may be configured to combine the video of the trainer 108 with the background image or video, to format video according to one or more formats, or perform other methods or operations described herein.

Background images or videos that may be combined with videos of trainers 108 performing workouts may include captured images or video, rendered images or video, or a combination of the two. As used herein, a captured image or video refers to an image or video captured by a video camera filming in the real world. A videographer with a video camera may capture video of the real world while the videographer is static or in motion (e.g., walking, running, biking, rowing). For example, the videographer 110a may use the video camera 106a to capture video while the videographer 110a runs in a real running race or along a running trail. A rendered image or video refers to an image or video generated by a game engine or rendering engine, such as the UNREAL ENGINE game engine, of a virtual world. For example, the exercise machine system 100 may include a game engine 115 that may be employed to render an image or video that may be used as a background image or video for combination with video of a trainer performing a workout. Additional details regarding combining video of a trainer with a background image or video are disclosed in U.S. Provisional Patent Application Ser. No. 63/156,801, filed Mar. 4, 2021, which is incorporated herein by reference in its entirety for all that it discloses.

In some embodiments, performance parameters of a trainer 108 performing a workout or of a videographer 110 as the videographer 110 captures video (e.g., to be used as background video) may be recorded as the trainer 108 and/or videographer 110 performs the workout. For example, performance parameters may be recorded for the trainers 108 as they perform their respective workouts and/or for the videographers 110a, 110b as they capture video while performing a workout. The performance parameters may include speed, cadence, heart rate, incline, or other performance parameters. Alternatively or additionally, a virtual speed of movement through a virtual environment depicted in a rendered video, an incline of the virtual environment, or other parameters of the rendered video or the virtual environment may be recorded. The performance parameters of the trainer 108 and/or the videographer 110 and/or the parameters of the rendered video or the virtual environment may be used to generate exercise machine control commands, as described in more detail elsewhere herein.

The various videos discussed herein may be formatted in any one of multiple video formats, at least some of which being capable of supporting a subtitle stream. Some example formats may include MPEG-4, Dynamic Adaptive Streaming over HTTP (MPEG-DASH), and HTTP Live Streaming (HLS).

Next, a producer (not shown) or other user may utilize a computer 114 to input exercise machine control commands for the video or the combined video into a video workout program, which may be encoded into a subtitle stream of the video, or may be encoded separately from the video or the combined video, such as in separate data packets. For example, where the video or the combined video is being produced to be utilized as a live video workout program, the producer may input the exercise machine control commands using the computer 114 synchronously or substantially synchronously with the video camera 106b, 106c capturing the video of the trainer 108a, 108b performing the workout (e.g., during a live event) and/or with generation of the combined video when one is generated. In this example, the producer may also give corresponding instructions to the trainer 108a, 108b, such as through an earpiece worn by the trainer 108a, 108b, to help the trainer 108a, 108b and the producer be in sync following a common script or plan for the workout. Alternatively, where the video or the combined video is produced to be utilized in a pre-recorded or archived video workout program, the producer may input exercise machine control commands using the computer 114 subsequent to the capture of the video of the trainer 108a, 108b performing or directing the workout and/or generation of the combined video, where one is generated (e.g., minutes, hours, or days after the live event). The exercise machine control commands may control operation of exercise machines at which the video workout program is executed.

In some embodiments, the producer may utilize the computer 114 to input environmental control commands into the video workout program, which may be encoded into the subtitle stream of the video or the combined video or may be encoded separately from the video or the combined video, such as in separate data packets. The environmental control commands may be input synchronously or substantially synchronously with the video camera 106b, 106c capturing the video of the trainer 108a, 108b performing the workout and/or with generation of the combined video when one is generated. The environmental control commands may control operation of one or more environmental control devices integrated with and/or in a vicinity of an exercise machine on which the video workout program is executed so as to control or affect an environment of a user of the exercise machine. Such environmental control devices may include heat lamps, fans, oil diffusers, scent dispensers, lights, humidifiers, mist dispensers, or other environmental control device. The environmental control devices may be smart devices, may be communicatively coupled to a corresponding exercise machine, and/or may be communicatively coupled to the network 118, to receive the environmental control commands in the video workout program. An example environmental control device is depicted in FIG. 1 as a fan 119 in a vicinity of an exercise machine 120c.

In some embodiments, the video workout program, including the video or the combined video and the control commands (which may be encoded in the subtitle stream of the video or the combined video, or may be encoded separately from the video or the combined video) may then be transmitted over the network 118 from the remote server 112 in the remote location 102 to a local server 116 in the local location 104.

The video workout program may then be transmitted from the local server 116 to be used in connection with an exercise machine 120a, 120b, 120c, 120d (hereinafter collectively “exercise machines 120” or generically “exercise machine 120”). For example, the video workout program may be transmitted from the local server 116 to the exercise machines 120, each of which may include a console 122a, 122b, 122c, 122d 122 (hereinafter collectively “console 122” or generically “console 122”), a touchscreen display, and/or other user interface. Alternatively or additionally, a separate tablet 124 may function as a console, or may function in connection with a console or other user interface, of the exercise machine 120, and may also include a display, such as a touchscreen display. The tablet 124 may communicate with the console 122 and/or with the exercise machine 120 via a network connection, such as a Bluetooth connection.

At the console 122 or the tablet 124, or more generally at the exercise machine 120, the video or the combined video and the control commands (which may be encoded in the subtitle stream of the video or the combined video, or may be encoded separately) may be decoded and/or accessed. Then, the console 122, the tablet 124, or more generally the exercise machine 120 may display the video or the combined video from the video workout program (e.g., of the trainer 108 performing a workout) while simultaneously controlling one or more moveable members of the exercise machine 120 using the exercise machine control commands and/or the output control commands. Additional details regarding controlling an exercise machine or environmental control device using exercise machine control commands or environmental control commands can be found in U.S. patent application Ser. No. 16/742,762, filed Jan. 14, 2020 and U.S. Provisional Patent Application Ser. No. 63/156,801, filed Mar. 4, 2021, each of which is incorporated herein by reference in its entirety for all that it discloses.

A user, such as a user 109, may perform a workout of a video workout program using the exercise machine 120 at which the video workout program is executed. Further, during performance of a workout by the user 109 using the video workout program on the exercise machine 120, a heart rate of the user 109 may be monitored by the console 122, the tablet 124, or more generally the exercise machine 120 or other device. This heart rate monitoring may be accomplished by receiving continuous heart rate measurements wirelessly (such as over Bluetooth or Ant+) from a heart rate monitoring device worn by the user 109, such as a heart rate strap 111b or a heart rate watch 111a, or other wearable heart rate monitor. Alternatively, the heart rate monitoring device may be built into another device, such as being built into handlebars, handgrips, or other portion of the exercise machine 120.

The heart rate strap 111b and the heart rate watch 111 are examples of sensors that may be used to generate and/or gather biological parameters, performance parameters, or other information of users of the exercise machines 120. Such sensors may generally include heart rate sensors (such as may be included in the heart rate strap 111b and the heart rate watch 111), VO2 max sensors, brain wave sensors, hydration level sensors, breathing/respiratory rate sensors, blood pressure sensors, current sensors, speed sensors (e.g., tachometers), weight sensors, pressure sensors, gait sensors, fingerprint sensors, biometric sensors (e.g., heart rate sensors, breathing sensors, gait sensors, fingerprint sensors), accelerometers, or other sensors. Such sensors may be integrated with, included in, coupled to, or otherwise associated with one or more of the exercise machines 120 and/or the users of the exercise machines 120.

In some embodiments in which biological parameters are collected (such as heart rate), a probability that the biological data is accurate may be determined. For example, when gathering heart rate data from a heart-rate strap or heart rate watch (such as the heart rate strap 111b or the heart rate watch 111a) worn by the user, it is possible that the heart rate data is inaccurate due to improper positioning of the strap, some debris or other object or material blocking all or part of a sensor of the heart rate watch or strap, poor connectivity with the receiver, etc. To account for this possibility, some embodiments may analyze the probability of the heart rate data being accurate, and where the probability of accuracy is below some threshold may discard, ignore, or otherwise not rely on the heart rate data.

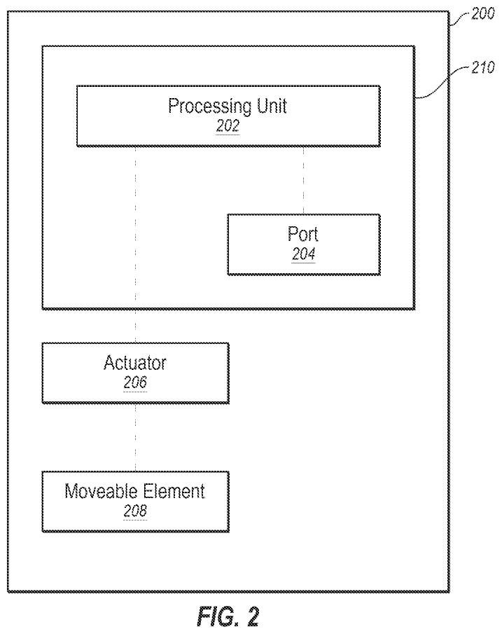

The exercise machine 120a is illustrated in FIG. 1 as a treadmill. The treadmill 120a may include multiple different moveable members, including a running belt 126a and a running deck 126b, which may include one or more operating parameters that are selectively adjustable within a limited range. During performance of a workout using a video workout program on the treadmill 120a, the running belt 126a may rotate and the running deck 126b may incline. One example of an operating parameter on the treadmill 120a is a speed of the running belt 126a. The running belt 126a may rotate at different speeds within a limited range. An actuator (see FIG. 2), for example a belt motor, may selectively adjust the speed at which the running belt 126a rotates within the limited range. Another example of an operating parameter on the treadmill 120a is the inclination of running deck 126b. The running deck 126b may be selectively inclinable to different angles within a limited range. An actuator, for example an incline motor, may selectively adjust the incline of the running deck 126b within the limited range.

The exercise machine 120b is illustrated in FIG. 1 as an elliptical machine. The elliptical machine 120b may include multiple different moveable members, including a flywheel 126c, foot rails or pedals 126d, and handles 126e, which include one or more operating parameters that are selectively adjustable within a limited range. During performance of a workout using a video workout program on the elliptical machine 120b, movement of the foot rails or pedals 126d and the handles 126e may cause the flywheel 126c to rotate. One example of an operating parameter on the elliptical machine 120b is the amount of resistance applied to the flywheel 126c. A differing amount of resistance can be applied to the flywheel 126c to make the movement of the foot rails or pedals 126d and the handles 126e more difficult or less difficult. An actuator, such as a brake, may be used to selectively adjust the amount of resistance that is applied to the flywheel 126c. Another example of an operating parameter on the elliptical machine 120b is the inclination of foot rails or pedals 126d. The foot rails or pedals 126d may be inclinable to different angles within a limited range. An actuator, such as an incline motor, may selectively adjust the incline of the foot rails or pedals 126d within the limited range. Yet another example of an operating parameter on exercise machine 120b is the stride length of the foot rails or pedals 126d and/or the handles 126e. The stride length of the foot rails or pedals 126d and/or the handles 126e may be adjustable to different distances within a limited range. An actuator, for example a stride length motor, may selectively adjust the stride length of the foot rails or pedals 126d and/or the handles 126e within the limited range.

The exercise machine 120c is illustrated in FIG. 1 as an exercise bike. The exercise bike 120c may include multiple different moveable members, including a flywheel 126f, pedals 126g, and a frame 126h, which include one or more operating parameters that are selectively adjustable within a limited range. During performance of a workout using a video workout program on the exercise bike 120c, movement of the pedals 126g may cause the flywheel 126f to rotate. One example of an operating parameter on the exercise bike 120c is the amount of resistance applied to the flywheel 126f. A differing amount of resistance can be applied to the flywheel 126f to make rotation of the pedals 126g more difficult or less difficult. An actuator, such as a brake, may be used to selectively adjust the amount of resistance that is applied to the flywheel 126f within the limited range. Another example of an operating parameter on the exercise bike 120c is the position of the frame 126h. The frame 126h may tilt forward, backward, or from side to side within a limited range. An actuator, such as a tilt motor, may selectively adjust the position of the frame 126h within the limited range.

The exercise machine 120d is illustrated in FIG. 1 as a rower machine. The rower machine 120d may include multiple different moveable members, including a flywheel 126i, a rowbar 126j, and a seat 126k, which include one or more operating parameters that are selectively adjustable within a limited range. During performance of a workout using a video workout program on the rower machine 120d, movement of the rowbar 126j may cause the flywheel 126i to rotate. One example of an operating parameter on the rower machine 120d is the amount of resistance applied to the flywheel 126i. A differing amount of resistance can be applied to the flywheel 126i to make pulling on the rowbar 126j more difficult or less difficult. An actuator, such as a brake, may be used to selectively adjust the amount of resistance that is applied to the flywheel 126i within the limited range.

FIG. 2 illustrates a block diagram of an example exercise machine 200. The exercise machine 200 of FIG. 2 may represent, and may include similar components to, any of the exercise machines 120 of FIG. 1, for example.

As disclosed in FIG. 2, the exercise machine 200 may include a processing unit 202, a receiving port 204, an actuator 206, and a moveable member 208. The moveable member 208 may be similar to any of the moveable members 126a-126c of FIG. 1, for example. The processing unit 202 may be communicatively connected to the receiving port 204 and may be included within a console 210, which may be similar to the console 122 of FIG. 1, for example. The processing unit 202 may also be communicatively connected to the actuator 206. In response to control commands executed by the processing unit 202, the actuator 206 may selectively adjust one or more operating parameters of the moveable member 208 within a limited range.

Data, including data in a video workout program, can be received by the exercise machine 200 through the receiving port 204. As stated previously, a video workout program may include video as well as control commands. Control commands may provide control instructions to an exercise machine (such as a treadmill, an elliptical machine, an exercise bike, or a rower machine) and/or one or more associated output control devices. Control commands may include, for example, control commands for a belt motor, an incline motor, chair recline motor, and/or other actuators. In addition to actuator control commands, control commands may further include distance control commands, time control commands, and/or heart rate zone control commands. These control commands may provide a series of actuator control commands for execution at specific times or at specific distances. For example, a control command for an actuator to be at a certain level for a specific amount of time or for a specific distance. These control commands may also provide a series of actuator control commands for execution at specific times or at specific distances based on a user's monitored heart rate or heart rate trends over time. For example, a control command for an actuator may dictate a certain heart rate zone for a certain amount of time or distance, and a difficulty level of this control command may be dynamically scaled based on a user's monitored heart rate in order to get or keep the user in the certain heart rate zone for the certain amount of time or distance. Additional details regarding dynamically scaling a difficulty level of a control command based on a user's monitored heart rate can be found in U.S. patent application Ser. No. 16/742,762, filed Jan. 14, 2020, which is incorporated herein by reference in its entirety for all that it discloses.

Using a control command, received at the receiving port 204 in a video workout program, such as a control command that is decoded from a subtitle stream of a video of a video workout program for example, the processing unit 202 may control the actuator 206 or output device on or associated with the exercise machine 200 in the sequence and at the times or distances specified by the control command. For example, actuator control commands that provide the processing unit 202 with commands for controlling a belt motor, an incline motor, a flywheel brake, stride length motor, a chair recline motor, or another actuator may be included in the control commands received in a video workout program at the exercise machine 200.

Actuator control commands can be received for different time segments or distance segments of a workout. For example, a ten-minute workout or a ten-minute mindfulness session may have twenty different control commands that provide the processing unit 202 with a different control command for controlling an actuator or output device every thirty seconds. Alternatively, a ten-mile workout may have twenty different control commands that provide a processing unit with a different control command for controlling an actuator or output device every half mile. Workouts or mental health improvement sessions may be of any duration or distance and different control commands may be received at any time or distance during the workout. Alternatively, a 5-minute workout may have 300 different control commands that provide the processing unit 202 with a different control command for controlling an actuator or output device once per second.

The control commands received in a video workout program at the exercise machine 200 may be executed by the processing unit 202 in a number of different ways. For example, the control commands may be received and then stored into a read/write memory that is included in or coupled to the processing unit 202. Alternatively, the control commands may be streamed to the exercise machine 200 in real-time. The control commands may also be received and/or executed from a portable memory device, such as a USB memory stick or an SD card.

Video workout programs can improve users' workout experiences. However, video workout programs may involve a significant amount of time and cost to produce, which may limit a total number of video workout programs available to users. Further, some users may be unable or uninterested in doing some of the available video workout programs. In view of the foregoing, the video workout programs users typically use may be limited and/or may grow stale over time, e.g., users may tire of repeating the same video workout programs. Some embodiments herein may expand a number of available video workout programs and/or customize the video workout programs for individual users. In general, for example, each of multiple video workout programs may be divided into segments, segments from two or more of the video workout programs may be selected based on user criteria specific to a given user, and the selected segments may be spliced together or otherwise combined to generate a custom video workout program for the given user.

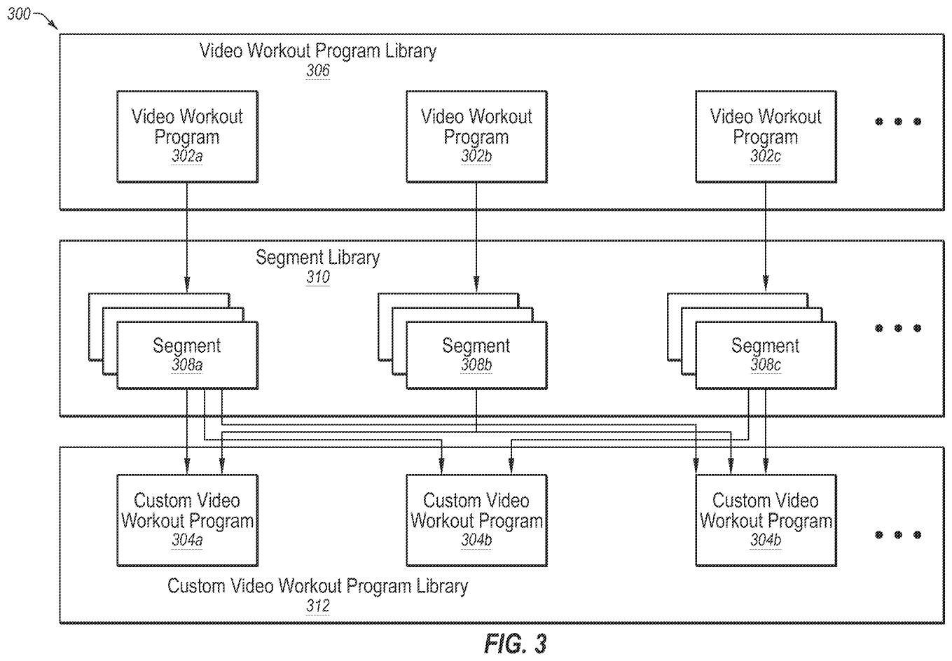

FIG. 3 is a block diagram 300 of example video workout programs 302a, 302b, 302c (hereinafter collectively “video workout programs 302” or generically “video workout program 302) and custom video workout programs 304a, 304b, 304c (hereinafter collectively “custom video workout programs 304” or generically “custom video workout program 304).

The video workout programs 302 may be generated in the same, similar, or different manner as described with respect to FIG. 1. Alternatively or additionally, the video workout programs 302 may be stored in a video workout program library 306, which may be stored on or accessible to the remote server 112 of FIG. 1, the local server 116 of FIG. 1, or the like. While three video workout programs 302 are illustrated in FIG. 3, the video workout program library 306 may more generally have two or more video workout programs 302. Ellipses within the video workout program library 306 indicate there may be more video workout programs 302 in the video workout program library 306 than the three illustrated in FIG. 3.

Each of the video workout programs 302 may be divided into multiple segments 308a, 308b, 308c (hereinafter collectively or generically “segments 308” or “segment 308”). For example, the video workout program 302a may be divided into multiple segments 308a; the video workout program 302b may be divided into multiple segments 308b; and the video workout program 302c may be divided into segments 308c. The segments 308 of each video workout program 302 may be the same or different lengths. For example, one of the segments 308a may have the same or different length as another of the segments 308a of the video workout program 302a. The segments 308 may be stored in a segment library 310, which may be stored on or accessible to the remote server 112 of FIG. 1, the local server 116 of FIG. 1, or the like. While three sets of segments 308 (corresponding to three different video workout programs 302) are illustrated in FIG. 3, the segment library 310 may more generally have segments 308 from two or more video workout programs 302. Ellipses within the segment library 310 indicate there may be more segments 308 in the segment library 310 than those illustrated in FIG. 3.

The video workout programs 302 may be divided into segments 308 by the remote server 112 of FIG. 1, the local server 116 of FIG. 1, or other server, system, or device. Locations, or times, at which each of the video workout programs 302 is divided may be the same across all video workout programs 302 or different, may be arbitrarily or randomly chosen, or may be chosen according to any desired method. In some embodiments, each video workout program 302 may include two or more sections and may be divided into segments 308 corresponding to the sections. For example, each video workout program 302 may include initial and final sections, e.g., a warmup and a cooldown, that bookend one or more workout sections, e.g., a VO2 max workout section, a tempo workout section, an endurance workout section, etc. and may be divided into different segments 308 that each includes a corresponding one of the warmup, a workout section, or the cooldown.

After the video workout programs 302 are divided into segments 308, a subset of all the segments 308 may be selected for inclusion in a custom video workout program 304 for a corresponding user. The segments 308 included in each subset may be selected based on one or more user criteria specific to the user, such as interests of the user, needs of the user, exercise machines the user has access to, scenery preferences of the user (e.g., the scenery or environments that appears in the segments 308), goals of the user (e.g., run a 5k race, bike a metric century race, etc.), educational content preferences of the user (e.g., topics or other content the user desires to learn about while working out), trainer preferences of the user (e.g., which trainer or trainers the user prefers to have in video workout programs), etc. The selected segments 308 may then be spliced together to generate a corresponding custom video workout program 304. For example, the arrows between segments 308 and the custom video workout programs 304 indicate the custom video workout program 304a has one or more segments 308a and one or more segments 308b; the custom video workout program 304b has one or more segments 308a and one or more segments 308c; and the custom video workout program 304c has one or more segments 308a, one or more segments 308b, and one or more segments 308c. The selection and splicing together of the segments 308 into the custom video workout programs 304 may be performed or controlled by the remote server 112 of FIG. 1, the local server 116 of FIG. 1, or other server, system, or device. The custom video workout programs 304 may be for the same user if each includes segments 308 selected based on user criteria of the same user or for different users if each includes segments 308 selected based on user criteria of different users.

The custom video workout programs 304 may be stored in a custom video workout program library 312, which may be stored on or accessible to the remote server 112 of FIG. 1, the local server 116 of FIG. 1, or the like. While three custom video workout programs 304 are illustrated in FIG. 3, the custom video workout program library 310 may more generally have two or more custom video workout programs 304. Ellipses within the custom video workout program library 312 indicate there may be more custom video workout programs 304 in the custom video workout program library 312 than those illustrated in FIG. 3.

The user criteria on which the selection of segments 308 for the custom video workout programs 304a is based may be collected or determined in any suitable manner. For example, the user criteria may be received as user input at any of the exercise machines 120, the tablet 124, or the like of FIG. 1. In some embodiments, the user criteria may be collected by administering a survey, e.g., asking the user one or more questions, before, during, or after execution of a video workout program at the exercise machine 120. The survey may be provided to the user via the tablet 124, the console 122 of the exercise machine 120, or other suitable device. Alternatively or additionally, the user criteria may be determined from an online fitness profile of the user. For example, the user may have an online fitness profile with IFIT or other Internet connected and interactive fitness platform from which the user criteria may be determined.

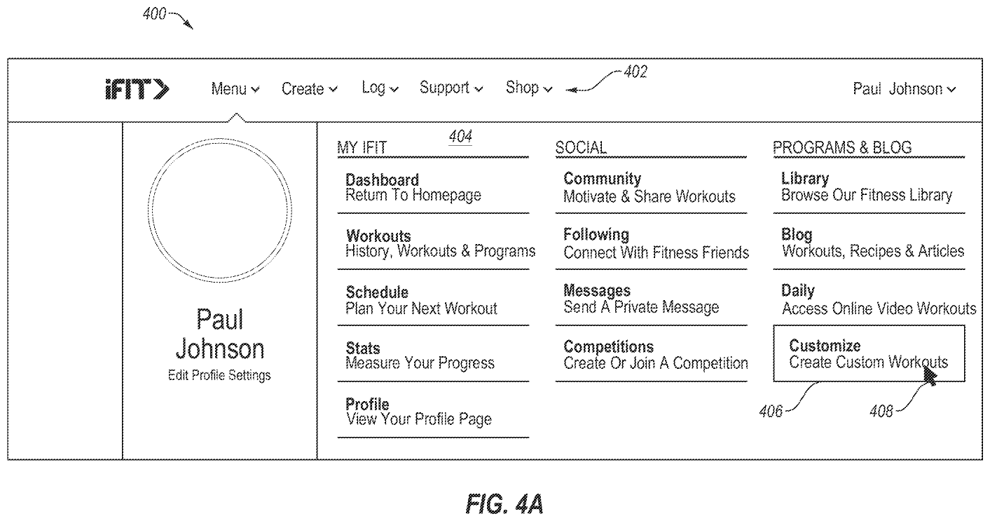

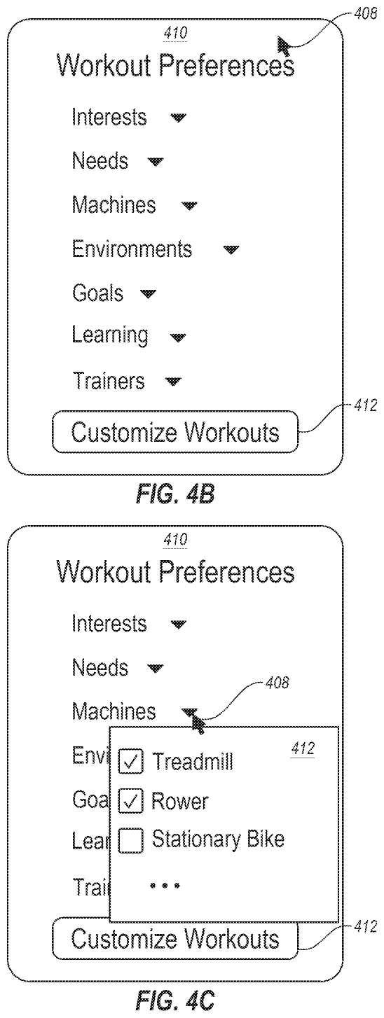

FIG. 4A is a screenshot of an example user interface (UI) 400 of an interactive fitness platform that may be used to collect user criteria from an online fitness profile of a user for customizing video workout programs. The UI 400 may be presented to the user on, e.g., the tablet 124 or the console 122 of FIG. 1 or other display device. The interactive fitness platform may include or have access to video workout programs, such as the video workout program library 306 and/or the video workout programs 302 of FIG. 3. The interactive fitness platform may make the video workout programs accessible over the Internet or more generally over a network to users.

The UI 400 may include various features or options that may be accessed by corresponding links, menus 402, or other UI elements within the UI 400. In some embodiments, selection of any of the menus 402 may open a corresponding drop-drown menu. For example, selection of the “Menu” menu 402 may open drop-down menu 404 with various options or features associated with, e.g., workouts, a social network, programs, and a blog. In some embodiments, the UI 400 and/or the menus 402 may be navigated by a user to turn on a custom workouts option (e.g., to get custom video workout programs 304) and/or enter user criteria used to generate custom video workout programs. For example, the drop-down menu 404 may include a customize option 406 that may be selected to turn custom workouts on or off and/or to enter user criteria. In some embodiments, when a mouse cursor 408 hovers over a selectable option within the drop-down menu 404 or other drop-down menus of the UI 400, the selectable option may be highlighted or undergo other visual transformation to indicate the location of the mouse cursor 408 and the option that will be selected if the mouse is operated accordingly (e.g., by providing a left mouse click input).

FIG. 4B is a screenshot of an example UI 410 that may be presented to a user in response to selection of, e.g., the customize option 406 of FIG. 4A. The UI 410 may permit a user to input user criteria, e.g., relating to one or more user preferences, and/or to turn on or off custom workouts. For example, the user preferences may include preferences regarding the user's interests, needs, machines, environments, goals, learning, and trainers. Selection of one or more of the preferences within the UI may open a drop-down menu and/or other UI element in which the user may input user criteria. Each drop-down menu or other UI element may include text input fields, one or more selectable items (e.g., items with associated check boxes that can be checked or unchecked or radio buttons that may be turned on or off), or the like. For example, selection of an Interests preference in the UI 410 may open a drop-down menu with selectable interests of the user, such as workout types (running, biking, rowing, etc.) or other interests, or other UI element(s) to input interests of the user. Selection of a Needs preference in the UI 410 may open a drop-down menu with selectable needs of the user or other UI element(s) to input needs of the user. In some embodiments, the Needs preference or other preferences of the UI 410 may be omitted or combined with another preference, such as the Interests preference. Selection of a Machines preference in the UI 410 may open a drop-down menu with selectable exercise machines that the user has access to or other UI element(s) to input exercise machines the user has access to.

For example, FIG. 4C is a screenshot of the UI 410 with a drop-down menu 412 that may be presented to the user in response to selection of the Machines preference. In this example, the drop-down menu 412 includes a list of exercise machines, such as a list of exercise machines with which the interactive fitness platform may operate or for which the interactive fitness platform has video workout programs. A checkbox next to each of the exercise machines in the list may be checked or unchecked to indicate whether the user is interested in video workout programs for use on or with the corresponding exercise machine. In FIG. 4C, checkboxes next to Treadmill and Rower may indicate the user is interested in video workout programs for use on or with treadmills and rowers. Ellipses within the drop-down menu 412 indicate there may be additional or other exercise machines in the list.

Returning to FIG. 4B, selection of an Environment preference in the UI 410 may open a drop-down menu with selectable environments (or scenery) or other UI element(s) to input goals of the user. In some embodiments, some video workout programs show (or appear to show) a trainer performing a workout in different environments or sceneries. For example, a trainer may be performing a workout (or may appear to be performing a workout) in or at a wooded forest, a desert, a beach, or the like and selection of one or more environments or sceneries in the drop-down menu by the user may indicate a preference by the user for video workout programs or portions of video workout programs that include the selected environments or sceneries. Selection of a Goals preference in the UI 410 may open a drop-down menu with selectable goals or other UI element(s) to input goals of the user. Examples of goals include completion of a given type of workout (e.g., cycling, running, rowing, or the like) or event (e.g., a bike race or Gran Fondo, a marathon, a sculling or sweep rowing race, or the like) for a given distance (e.g., 100 miles, 60 miles, 40 miles, marathon, half marathon, 10 kilometers, 5 kilometers, 2 miles, 2 kilometers, 1 mile, or the like) or time (e.g., 10 hours, 5 hours, 3 hours, 1 hour, 30 minutes, or the like). In some embodiments, the drop-down menu opened responsive to selection of the Goals preference may accept input to specify a goal date or timeline (e.g., 3 months from now) by which to complete the goal workout or event for the given distance or time. Selection of a Learning preference in the UI 410 may open a drop-down menu with selectable educational content preferences of the user or other UI element(s) to input educational content preferences of the user. Examples of selectable educational content preferences may include one or more topics (e.g., math, history, language, finance, etc.), subtopics (e.g., calculus, algebra, world history, US history, French, Spanish, English, German, etc.), or the like). Selection of a Trainers preference in the UI 410 may open a drop-down menu with selectable trainers. E.g., some trainers may appear in multiple video workout programs the selection of one or more trainers in the drop-down menu by the user may indicate a preference by the user for video workout programs from those trainers.

After entering user criteria, e.g., via the UI 410, the user may select a button 414 or other UI element to customize future workouts according to the user criteria. For example, the user criteria may be saved in the online fitness profile of the user and the remote server 112, the local server 116, or other system or device may access the user criteria from the online fitness profile and select segments of multiple video workout programs based on the user criteria for inclusion in one or more custom video workout programs for the user.

In some embodiments, the segments 308 of FIG. 3 may be tagged and/or may include metadata or attribute values indicative of attributes of the segment 308 that relate to the user criteria. For example, attribute values of each segment 308 may include one or more values for interests and/or needs the segment 308 relates to or satisfies, one or more values for types of exercise machines (e.g., treadmill, rower machine, stationary bike, etc.) the segment 308 may be executed at, one or more values for an environment or scenery depicted in the segment 308, one or more values for an objective, purpose, or goal of the segment 308, one or more values for educational content included in the segment 308, one or more values for trainers featured in the segment 308, or other values for other attributes. When selecting segments 308 to include in a given custom video workout program 304, values of the user criteria may be compared to and/or matched against attribute values of the segments 308. In some embodiments, segments 308 that include the highest match scores, that exceed a threshold score, or that satisfy some other criteria may be selected as the segments 308 for inclusion in a corresponding one of the custom video workout programs 304.

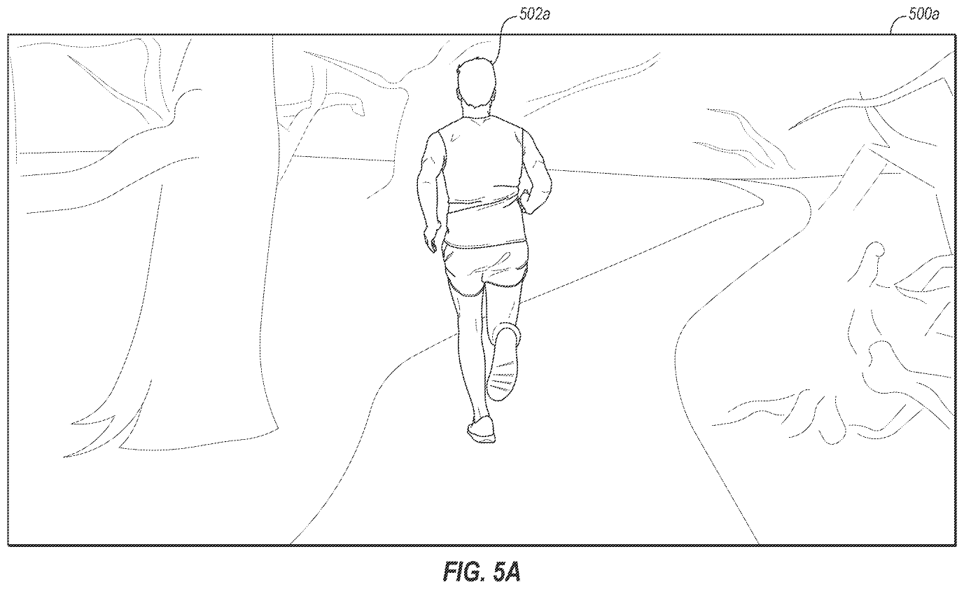

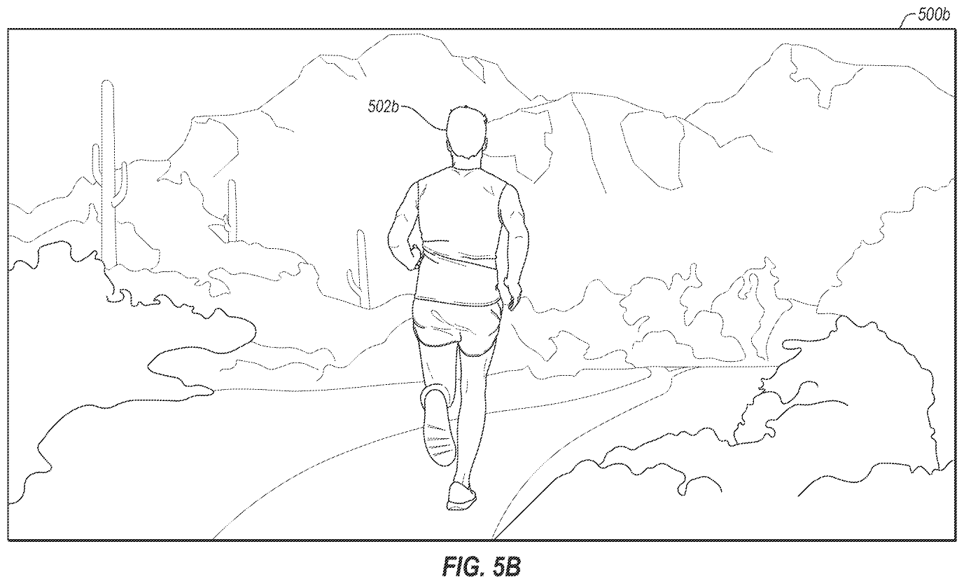

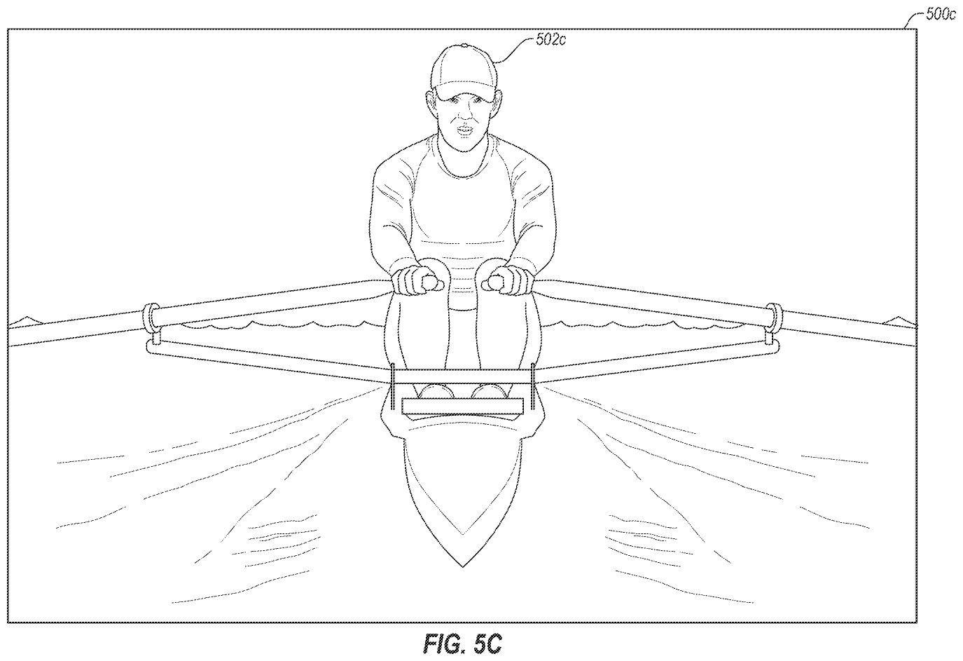

FIGS. 5A-5C illustrate video frames 500a, 500b, 500c (hereinafter collectively “video frames 500” or generically “video frame 500”) of a custom video workout program that may be generated as described herein. For example, the video frames 500 may be taken from any of the custom video workout programs 304 of FIG. 3. Each of the video frames 500 may be of a different one of multiple segments of video workout programs that were selected based on user criteria of a given user and spliced together to form the custom video workout program. For example, the video frame 500a may be of one of the segments 308a of the video workout program 302a of FIG. 3, the video frame 500b may be of one of the segments 308b of the video workout program 302b of FIG. 3, and the video frame 500c may be of one of the segments 308c of the video workout program 302c of FIG. 3.

In this example, user criteria of the given user may indicate that the user prefers workouts that feature a first trainer 502a and/or a second trainer 502b, the user prefers environments or sceneries that include wooded forest and desert, the user is interested in running and rowing workouts, and/or the user has access to a treadmill and a rower machine. Accordingly, the segment represented by the video frame 500a may be selected for inclusion in the custom video workout program because it features the first trainer 502a, includes a wooded forest environment or scenery, involves a running workout, and/or may be executed on a treadmill. Alternatively or additionally, the segment represented by the video frame 500b may be selected for inclusion in the custom video workout program because it features the first trainer 502a, includes a desert environment or scenery, involves a running workout, and/or may be executed on a treadmill. Alternatively or additionally, the segment represented by the video frame 500c may be selected for inclusion in the custom video workout program because it features the second trainer 502b, includes a wooded forest environment or scenery, involves a rowing workout, and/or may be executed on a rower machine.

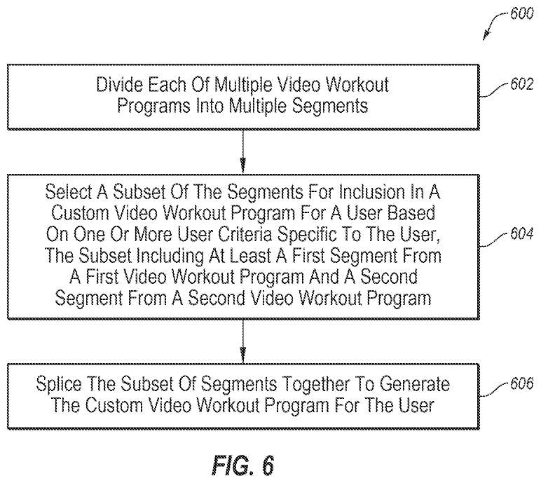

FIG. 6 illustrates a flowchart of an example method 600 to generate a custom video workout program for a user. The method 600 may be performed, in some embodiments, by one or more applications, devices, or systems, such as by the computer 114, the remote server 112, the local server 116, or some combination thereof, and/or other applications, devices, or systems herein. In these and other embodiments, the method 600 may be performed by one or more processors based on one or more computer-readable instructions stored on one or more non-transitory computer-readable media. The method 600 will now be described in connection with FIGS. 1-5C.

The method 600 may include, at action 602, dividing each of multiple video workout programs into multiple segments. For example, each of the video workout programs 302 of FIG. 3 may be divided into multiple segments 308.

The method 600 may include, at action 604, selecting a subset of the segments for inclusion in a custom video workout program for the user based on one or more user criteria specific to the user. The subset may include at least a first segment from a first video workout program and a second segment from a second video workout program. In some embodiments, the first video workout program may be executable on a first type of exercise machine and the second video workout program may be executable on a second type of exercise machine that is different than the first type of exercise machine. For example, the first video workout program may be executable on a treadmill while the second video workout program may be executable on a stationary bike.

In some embodiments, the remote server 112 of FIG. 1 may select one or more of the segments 308a of FIG. 3, one or more of the segments 308b of FIG. 3, one or more of the segments 308c of FIG. 3, and/or one or more of the segments from which the video frames 500 of FIGS. 5A-5C were taken for inclusion in the custom video workout program for the user based on the one or more user criteria. The one or more user criteria may include at least one of: interests of the user; needs of the user; exercise machines the user has access to; scenery preferences of the user; goals of the user; educational content preferences of the user; or trainer preferences of the user.

The method 600 may include, at action 606, splicing the subset of segments together to generate the custom video workout program for the user. For example, the remote server 112 may splice together the segments selected at the action 604. In some embodiments, the custom video workout program may include segments that are executable on different types of exercise machines. For example, where the first and second video workout programs are executable on different types of exercise machines, the first segment of the custom video workout program may be executable on the first type of exercise machine and the second segment of the custom video workout program may be executable on the second type of exercise machine.

In some embodiments, one or more of the segments may include a rating or score indicative of how fun, enjoyable, or exciting each segment is. The rating or score may be inherited from a rating or score of the original video workout program from which the segment comes. Alternatively or additionally, the rating or score may be based on one or more user reviews, ratings, or scores of the original video workout program or the segment itself each, or of a creator of the video workout program or an administrator or other individual associated with an interactive fitness platform on which the original video workout program or the segment is available. In these and other embodiments, selection of the subset of segments at the action 604 may be further based on an excitement parameter (e.g., an excitement rating or score), a fun parameter (e.g., a fun rating or score), or an enjoyment parameter (e.g., an enjoyment rating or score) of each of the segments.

In some embodiments, the method 600 may further include executing the custom video workout program at one or more exercise machines to enable the user to perform a custom workout. The custom workout may include segments of workouts included in the corresponding segments of the video workout programs that were spliced together to generate the custom video workout program. The selecting of the subset of segments at action 604 may include dynamically selecting one or more subsequent segments of the subset after execution at the one or more exercise machines of at least a portion of a prior segment of the subset. For example, the second segment may be selected after execution of at least a portion of the first segment at the one or more exercise machines. In some embodiments, the method 600 may further include monitoring, at the one or more exercise machines, one or more performance parameters of the user during execution of the prior segment of the subset. The dynamically selecting of the one or more subsequent segments of the subset may be further based on the one or more performance parameters of the user. For example, if the performance parameters indicate the user is underperforming during execution of the prior segment, a subsequent segment of, e.g., lower intensity or difficulty may be selected, whereas a subsequent segment of, e.g., higher intensity or difficulty may be selected if the performance parameters indicate the user is overperforming.

In some embodiments, the method 600 may further include, prior to the selecting of the subset of segments at action 604, determining the one or more user criteria. The user criteria may be determined by presenting one or more survey questions to the user before, during, or after execution of a video workout program at an exercise machine and receiving one or more responses to the one or more survey questions from the user.

Some embodiments herein may include, instead of or in addition to generating custom video workout programs, generating custom series of video workout programs for users. Each series may be presented to users as, e.g., a training plan. In aggregate and when executed over time, each series of two or more video workout programs may help users achieve one or more fitness goals.

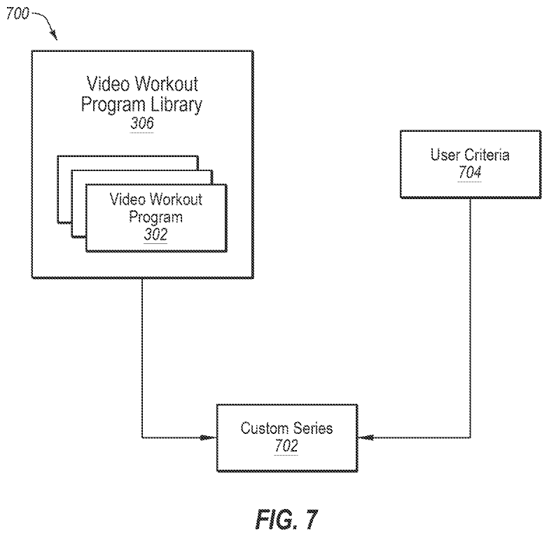

FIG. 7 is a block diagram 700 of an example method of generating a custom series of video workout programs 702 for a user from video workout programs 302 (and/or custom video workout programs 304) based on user criteria 704. In general, user criteria 704 specific to a user may be determined, e.g., by the remote server 112 of FIG. 1, the local server 116 of FIG. 1, and/or other server, device, or system. The user criteria 704 may include one or more fitness goals of the user or other user criteria. Based on the user criteria 704, a subset of two or more of the video workout programs 302 in the video workout program library 306 may be identified that match the user criteria and/or to assist the user in achieving the one or more fitness goals. The subset of two or more video workout programs 302 may be identified, e.g., by the remote server 112 of FIG. 1, the local server 116 of FIG. 1, and/or other server, device, or system. The subset of two or more video workout programs 302 may then be assembled into a custom series 702 of video workout programs for the user to be executed at one or more exercise machines for the user over a period of time. The subset of two or more video workout programs 302 may be assembled into the custom series 702, e.g., by the remote server 112 of FIG. 1, the local server 116 of FIG. 1, and/or other server, device, or system. In some embodiments, the two or more video workout programs 302 of the custom series 702 may be tentatively scheduled for one or more specific days in the future and/or some or all of the custom series 702 may be presented to the user. For example, each of the two or more video workout programs 302 in the custom series 702 may be scheduled for a specific future day and shown on a calendar on the assigned day. The calendar with the scheduled video workout programs 302 may be presented to the user on a display device, such as on the tablet 124 or the console 122 of FIG. 1.

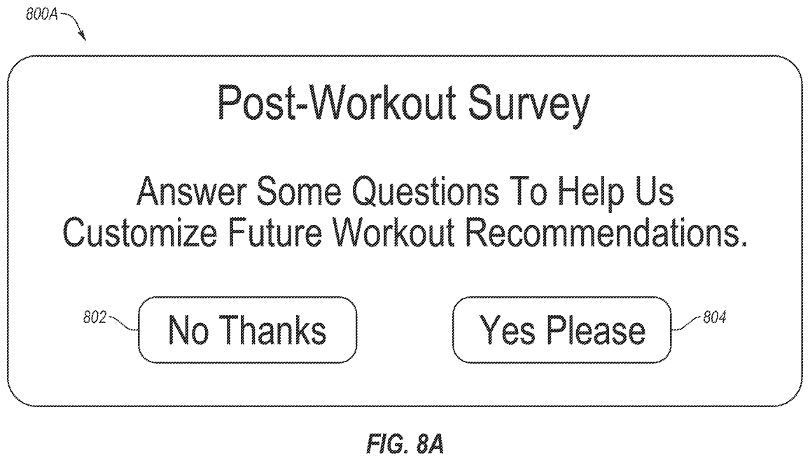

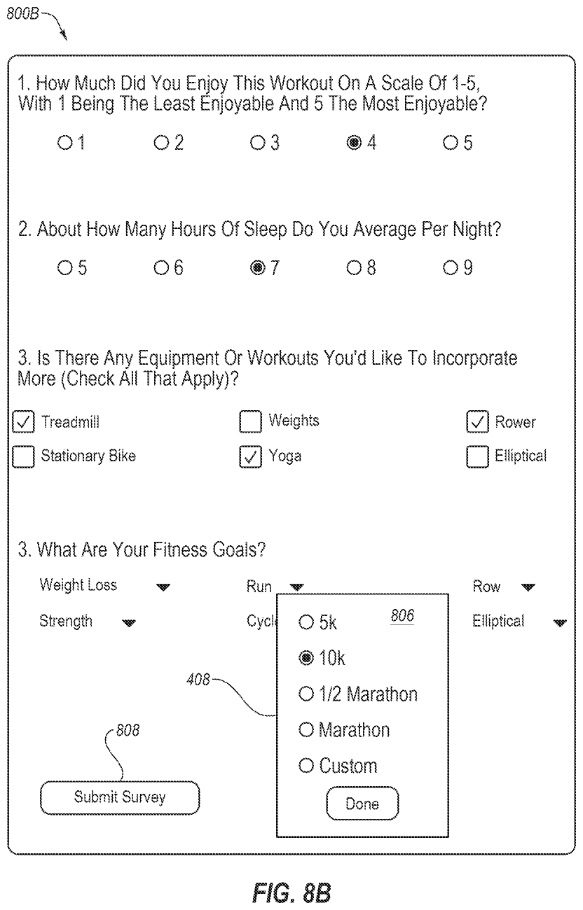

FIGS. 8A and 8B include screenshots of example UIs 800A, 800B that may be used to collect user criteria from a user for generating custom series of video workout programs. Alternatively or additionally, the user criteria collected via the UI 400 of FIG. 4A may be used for generating custom series of video workout programs and/or the user criteria collected via the UIs 800A, 800B may be used to customize video workout programs as described elsewhere herein. The UIs 800A, 800B may be presented to the user on, e.g., the tablet 124 or the console 122 of FIG. 1 or other display device.

The UI 800A may be presented to the user at the conclusion of a video workout program or at some other time, e.g., before or during a execution of the video workout program. In some embodiments, the UI 800A may inform the user that answering questions may help customize future workout recommendations and/or may be used to generate a custom series of video workout programs for the user. The UI 800A may include a button 802 or other UI element that may be selected by the user to decline to answer the questions and/or a button 804 or other UI element that may be selected by the user to answer the questions.

The UI 800B may be presented to the user in response to selection of the button 804. In some embodiments, the UI 800B may include one or more survey questions, answers to which may be used as an input in generating a custom series of video workout programs for the user. Each of the one or more survey questions may relate to at least one of a level of engagement of the user with the video workout program; a level of enjoyment of the user of the video workout program (see, e.g., question 1 in the UI 800B); one or more types of exercise machines the user desires to use more for video workout programs in the future (see, e.g., question 3 in the UI 800B); one or more types of exercise machines the user desires to use less for video workout programs in the future; the one or more fitness goals of the user (see, e.g., question 4 in the UI 800B); or a typical amount of sleep of the user (see, e.g., question 2 in the UI 800B). Each of the questions may include one or more selectable items, e.g., items with check boxes or radio buttons, a text entry field, a dropdown menu with one or more selectable items, or other UI element(s) to receive the user's answer or answers to each question. For example, question 4 in the UI 800B includes various drop-down menus relating to different types of exercise or events and a run drop-down menu 806 that may be opened (e.g. response to selection of “Run” under question 4) to select one or more running-related goals. The UI 800B may include a button 808 or other UI element to conclude the survey. Selection of the button 808 may upload any or all of the user's answers to the questions in the UI 800B to, e.g., the local server 116 of FIG. 1, the remote server 112 of FIG. 1, the interactive fitness platform, or other server, device, or system.

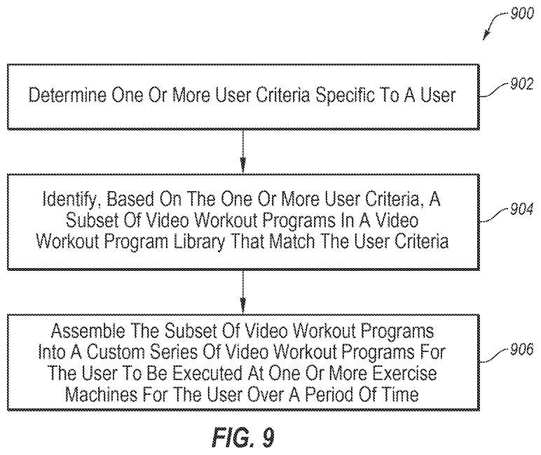

FIG. 9 illustrates a flowchart of an example method 900 to generate a custom series of video workout programs for a user. The method 900 may be performed, in some embodiments, by one or more applications, devices, or systems, such as by the computer 114, the remote server 112, the local server 116, or some combination thereof, and/or other applications, devices, or systems herein. In these and other embodiments, the method 900 may be performed by one or more processors based on one or more computer-readable instructions stored on one or more non-transitory computer-readable media. The method 900 will now be described in connection with FIGS. 1-2 and 7-8B.

The method 900 may include, at action 902, determining one or more user criteria specific to a user. The one or more user criteria may include one or more fitness goals of the user. In some embodiments, the one or more user criteria may be determined by the remote server 112 by presenting the user with one or more questions, e.g., a survey, and/or from an online fitness profile of the user. For example, the remote server 112 may present one or more survey questions to the user before, during, or after execution of a video workout program at an exercise machine and may receive one or more responses to the one or more survey questions from the user. The remote server 122 may present the one or more survey questions to the user aurally, visually, or both aurally and visually. For example, the remote server 122 may present the one or more survey questions to the user via the UI 800A and/or the UI 800B. Each of the one or more survey questions may relate to at least one of: a level of engagement of the user with the video workout program; a level of enjoyment of the user of the video workout program; one or more types of exercise machines the user desires to use more for video workout programs in the future; one or more types of exercise machines the user desires to use less for video workout programs in the future; one or more fitness goals of the user; or a typical amount of sleep of the user.

The method 900 may include, at action 904, identifying, based on the one or more user criteria, a subset of video workout programs in a video workout program library that match the user criteria. For example, the remote server 112 may identify a subset of two or more of the video workout programs 302 (and/or the custom video workout programs 304) from the video workout program library 306 based on the user criteria 704. Alternatively or additionally, the subset of video workout programs that match the user criteria may assist the user in achieving the one or more fitness goals.

The method 900 may include, at action 906, assembling the subset of video workout programs into a custom series of video workout programs for the user to be executed at one or more exercise machines for the user over an ongoing period of time. For example, the remote server 112 may assemble the subset of two or more of the video workout programs 302 into the custom series 702.

In some embodiments, the method 900 may further include providing access to the one or more user criteria to a trainer. The method 900 may also include receiving input from the trainer, e.g., one or more recommendations or suggestions of the trainer with respect to which video workout programs 302 or types of video workout programs 302 to include in the custom series 702. The identifying of the subset of video workout programs based on the one or more user criteria at action 904 may include identifying the subset of video workout programs based on the input from the trainer.

In some embodiments, the method 900 may further include presenting educational content to the user at an output device included in or communicatively coupled to a given exercise machine of the one or more exercise machines during execution of a given video workout program of the one or more video workout programs at the given exercise machine. The method 900 may further include presenting, through the output device, one or more questions to the user that are related to the educational content. The method 900 may further include monitoring, at the given exercise machine, a performance parameter of the user during execution of the given video workout program at the given exercise machine. In some embodiments, a difficulty of the one or more questions presented to the user at any given time may depend on at least one of the performance parameter at the given time or a difficulty of the given video workout program at the given time. For example, relatively easier questions may be presented to the user at times when the user is performing at a relatively higher level and/or when the difficulty of the given video workout program is relatively higher. Alternatively or additionally, relatively harder questions may be presented to the user at times when the user is performing at a relatively lower level and/or when the difficulty of the given video workout program is relatively lower.

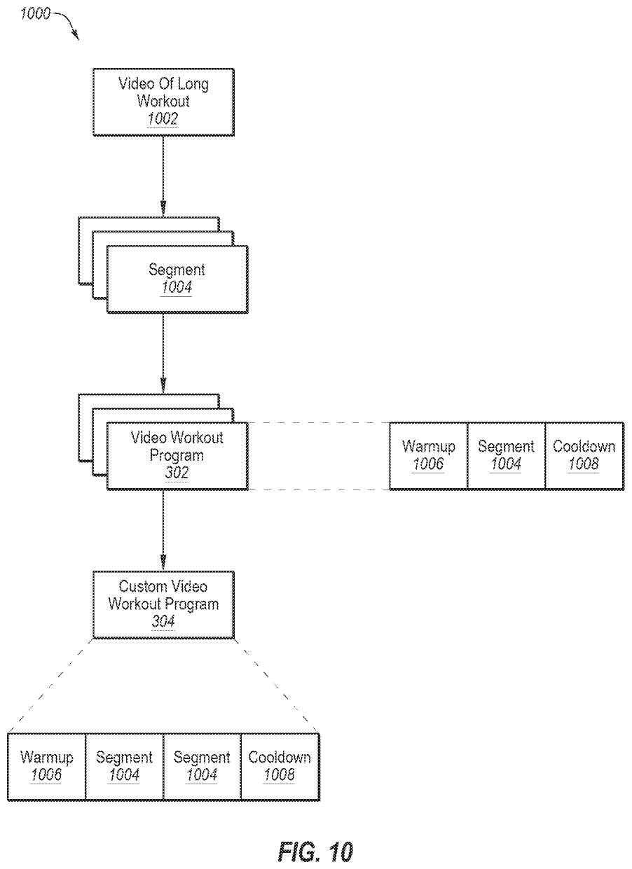

FIG. 10 is a block diagram 1000 of an example method to generate custom video workout programs. Some embodiments herein may involve filming a trainer performing a relatively long workout and dividing a resulting video 1002 of the long workout into multiple video segments 1004. Each of the video segments 1004 may show the trainer performing a different portion of the relatively long workout. Each of the video segments 1004 may be included in a different video workout program 302 (and/or custom video workout program 304). For example, a video 1002 of the trainer running the Boston Marathon or other well-known event may be broken into multiple segments 1004 covering a different portion of the event course so that users can experience the entire event in smaller portions even if they do not wish to experience the entire event at one time. Each of the video workout programs 302 created from the segments 1004 of the video 1002 may include a warmup 1006, a corresponding video segment 1004, and a cooldown 1008, as indicated in FIG. 10. In some embodiments, the warmup 1006 and/or the cooldown 1008 may include separate video from the video segment 1004 and/or no video at all. Some users may desire to combine two or more of the video workout programs 302 made from the video segments 1004 of the video 1002 together to complete them as a single workout but may be frustrated in this respect if they have to complete the cooldown 1008 of a preceding video workout program 302 and a warmup 1006 of a subsequent video workout program 302 before getting to the workout of the video segment 1004. Accordingly, in some embodiments, the user may provide input to combine two or more of the video workout programs 302 into a custom video workout program 304. In response to the input, the video segments 1004 of the two or more video workout programs 302 may be spliced together without any intervening warmups 1006 or cooldowns 1008 between a first one of the video segments 1004 and a last one of the video segments 1004 of the two or more video workout programs 302. In the example of FIG. 10, the custom video workout program 304 includes two sequential video segments 1004 with no intervening warmups 1006 or cooldowns 1008 between the first and last video segments 1004 but may more generally include two or more sequential video segments 1004 with no intervening warmups 1006 or cooldowns 1008 between the first and last video segments 1004 of the custom video workout program 304. In some embodiments, the user may select the video workout programs 302 to combine into the custom video workout program 304 prior to beginning the first video workout program 302. In some embodiments, the user may select the video workout programs 302 to combine into the custom video workout program 304 during the first (or other) video workout program 302. In some embodiments, the user may select the video workout programs 302 to combine into the custom video workout program 304 after and/or near an end of the first video workout program 302.

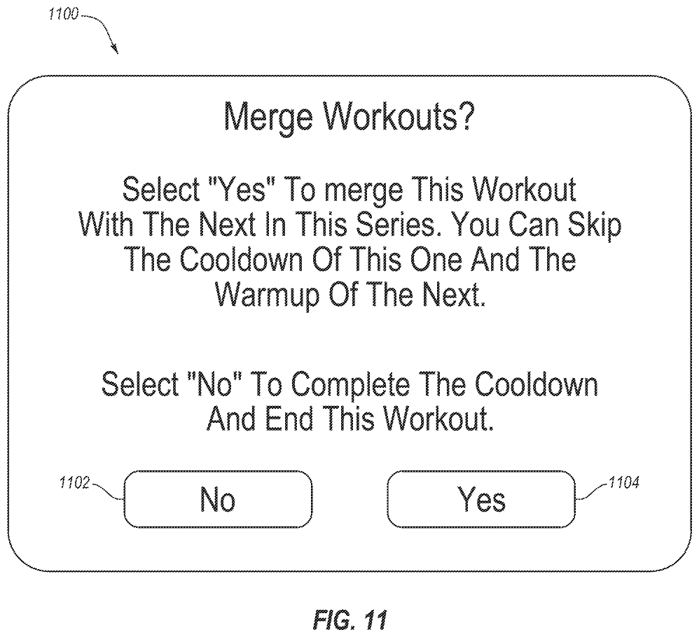

FIG. 11 includes a screenshot of an example UI 1100 to generate a custom video workout program. The UI 1100 may be presented to the user on, e.g., the tablet 124 or the console 122 of FIG. 1 or other display device.

The UI 1100 may be presented to the user before, during, or at or after an end of a video workout program executed at an exercise machine. In some embodiments, the UI 1100 may be presented to the user in response to a suitable input, such as user selection of a button or other UI element to merge two or more video workout programs together. The UI 1100 may inform the user that two video workout programs (each referred to as “workout” in the UI 1100) may be combined together while dropping the cooldown of a preceding video workout program and a warmup of a subsequent video workout program. The UI 1100 may include a button 1102 or other UI element that may be selected by the user to decline to combine the video workout programs and/or a button 1104 or other UI element that may be selected by the user to combine the video workout program.

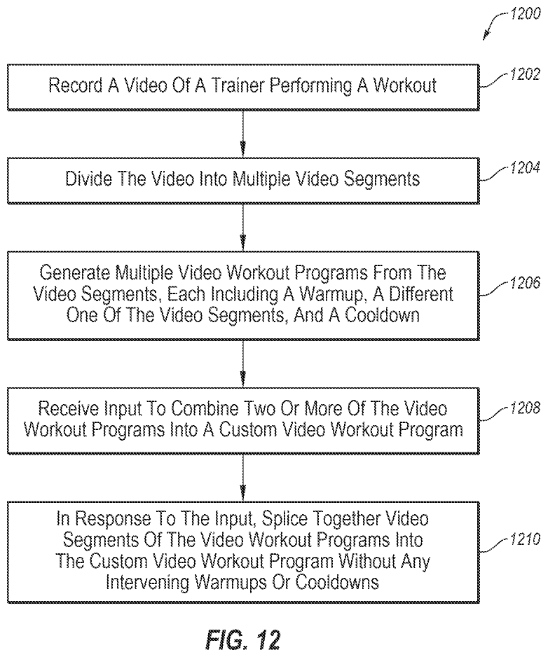

FIG. 12 illustrates a flowchart of another example method 1200 to generate a custom video workout program for a user. The method 1200 may be performed, in some embodiments, by one or more applications, devices, or systems, such as by the computer 114, the remote server 112, the local server 116, or some combination thereof, and/or other applications, devices, or systems herein. In these and other embodiments, the method 1200 may be performed by one or more processors based on one or more computer-readable instructions stored on one or more non-transitory computer-readable media. The method 1200 will now be described in connection with FIGS. 1-2 and 11-11.

The method 1200 may include, at action 1202, recording a video of a trainer performing a workout. For example, action 1202 may include a video camera 106 recording video 1002 that includes a trainer 108 performing a workout or is combined with video of a trainer 108 performing a workout and/or the local server 116 and/or the remote server 112 storing video 1002 of the trainer 108 performing the workout. The video 1002 may be of or include an event that may be unknown or well-known, such as a well-known running, biking, rowing, or other race or event. The video 1002 and the workout may be relatively long, e.g., long enough that many users may desire to experience it in smaller segments.

The method 1200 may include, at action 1204, dividing the video into multiple video segments. For example, action 1202 may include the remote server 112 dividing the video 1002 into the video segments 1004.

The method 1200 may include, at action 1206, generating multiple video workout programs from the video segments. Each video workout program may include a warmup, a different one of the video segments, and a cooldown. For example, the remote server 112 may generate video workout programs 302 from the video segments 1004 and each of the video workout programs 302 may include a warmup 1006, a different one of the video segments 1004, and a cooldown 1008.

The method 1200 may include, at action 1208, receiving input to combine two or more of the video workout programs into a custom video workout program. For example, the remote server 112 may receive user input via the tablet 124 and/or the console 122 to combine two or more of the video workout programs 302 into the custom video workout program 304 of FIG. 10. The tablet 124 and/or the console 122 may present a UI to the user to receive the input, such as the UI 1100.

The method 1200 may include, at action 1210, and in response to the input, splicing together video segments of the two or more of the video workout programs into the custom video workout program without any intervening warmups or cooldowns between a first one of the video segments of the two or more of the video workout programs and a last one of the video segments of the two or more of the video workout programs. For example, action 1210 may include the remote server 112 splicing the video segment 1004 of a subsequent video workout program 302 together with the video segment 1004 of a preceding video workout program 302 while dropping the cooldown 1008 of the preceding video workout program 302 and the warmup 1006 of the subsequent video workout program 302 from the resulting custom video workout program 304.

In some embodiments, the video workout programs include first and second video workout programs. The first video workout program may include a first video segment preceded by a first warmup and followed by a first cooldown. The second video workout program may include a second video segment preceded by a second warmup and followed by a second cooldown. The input to combine the two or more of the video workout programs into the custom video workout program may include input to append the second video workout program to the first video workout program. The method 1200 may further include executing the first video workout program at an exercise machine to enable a user to perform a portion of the workout. The method 1200 may further include terminating execution of the first video workout program at or prior to the first cooldown and initiating execution of the second video workout program at an end of or following the second warmup to splice the first video segment and the second video segment together.

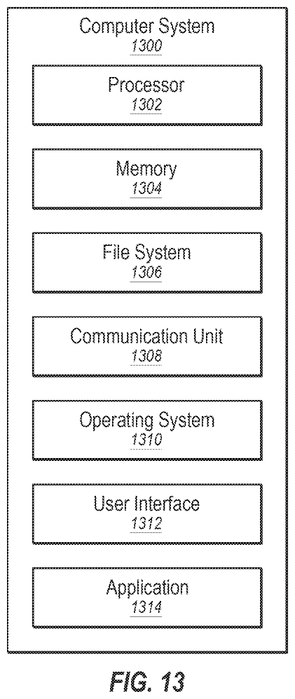

FIG. 13 illustrates an example computer system 1300 that may be employed in performing or controlling performance of one or more of the methods or actions herein. In some embodiments, the computer system 1300 may be part of any of the systems or devices described in this disclosure. For example, the computer system 1300 may be part of any of the video cameras 106, the computer 114, the remote server 112, the game engine 115, the local server 116, the exercise machines 120, the console 122, or the tablet 124 of FIG. 1.

The computer system 1300 may include a processor 1302, a memory 1304, a file system 1306, a communication unit 1308, an operating system 1310, a user interface 1312, and an application 1314, which all may be communicatively coupled. In some embodiments, the computer system may be, for example, a desktop computer, a client computer, a server computer, a mobile phone, a laptop computer, a smartphone, a smartwatch, a tablet computer, a portable music player, an exercise machine console, a video camera, or any other computer system.

Generally, the processor 1302 may include any suitable special-purpose or general-purpose computer, computing entity, or processing device including various computer hardware or software applications and may be configured to execute instructions stored on any applicable computer-readable storage media. For example, the processor 1302 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 1302 may interpret and/or execute program instructions and/or process data stored in the memory 1304 and/or the file system 1306. In some embodiments, the processor 1302 may fetch program instructions from the file system 1306 and load the program instructions into the memory 1304. After the program instructions are loaded into the memory 1304, the processor 1302 may execute the program instructions. In some embodiments, the instructions may include the processor 1302 performing one or more actions of the methods 1300, 1400, 1500, 1600 of FIGS. 13-16.

The memory 1304 and the file system 1306 may include computer-readable storage media for carrying or having stored thereon computer-executable instructions or data structures. Such computer-readable storage media may be any available non-transitory media that may be accessed by a general-purpose or special-purpose computer, such as the processor 1302. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1302 to perform a certain operation or group of operations, such as one or more actions of the methods 1300, 1400, 1500, 1600 of FIGS. 13-16. These computer-executable instructions may be included, for example, in the operating system 1310, in one or more applications, or in some combination thereof.

The communication unit 1308 may include any component, device, system, or combination thereof configured to transmit or receive information over a network, such as the network 118 of FIG. 1. In some embodiments, the communication unit 1308 may communicate with other devices at other locations, the same location, or even other components within the same system. For example, the communication unit 1308 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, a cellular communication device, etc.), and/or the like. The communication unit 1308 may permit data to be exchanged with a network and/or any other devices or systems, such as those described in the present disclosure.

The operating system 1310 may be configured to manage hardware and software resources of the computer system 1300 and configured to provide common services for the computer system 1300.

The user interface 1312 may include any device configured to allow a user to interface with the computer system 1300. For example, the user interface 1312 may include a display, such as an LCD, LED, or other display, that is configured to present video, text, application user interfaces, and other data as directed by the processor 1302. The user interface 1312 may further include a mouse, a track pad, a keyboard, a touchscreen, volume controls, other buttons, a speaker, a microphone, a camera, any peripheral device, or other input or output device. The user interface 1312 may receive input from a user and provide the input to the processor 1302. Similarly, the user interface 1312 may present output to a user.

The application 1314 may be one or more computer-readable instructions stored on one or more non-transitory computer-readable media, such as the memory 1304 or the file system 1306, that, when executed by the processor 1302, is configured to perform one or more actions of the methods 600, 900, 1200 of FIGS. 6, 9, and 12. In some embodiments, the application 1314 may be part of the operating system 1310 or may be part of an application of the computer system 1300, or may be some combination thereof. In some embodiments, the application 1314 may include a machine learning model. In general, the machine learning model may be trained based on sample data, known as training data, in order to make predictions or decisions without being explicitly programmed to do so. The machine learning model may employ machine learning algorithms, and may be supervised or unsupervised. The machine learning model may be trained over time to become more and more accurate. The machine learning model may be trained, for example, using a Decision Tree, Naive Bayes Classifier, K-Nearest Neighbors, Support Vector Machines, or Artificial Neural Networks. The machine learning model may be employed in any of the methods herein to perform actions with increasing effectiveness and accuracy over time, as the machine learning model learns and is periodically retrained to make more accurate predictions or decisions.

### INDUSTRIAL APPLICABILITY

Various modifications to the embodiments illustrated in the drawings will now be disclosed.

Some example methods disclosed herein generate custom video workout programs. Video workout programs in a library may be divided into multiple segments and the segments may be combined together in any manner or sequence to generate one of a kind custom video workout programs. Accordingly, some embodiments may make a relatively small video workout program library, or more generally a video workout program library of any size, feel larger than it actually is to users as users may never, or infrequently, or less frequently than otherwise would occur in the absence of customized video workout programs, experience the exact same video workout program multiple times. Even though segments of a given custom video workout program may have been experienced at some point by a user, any given combination of segments may be new and may therefore feel like a new video workout program to the user. New video workout programs may be rejuvenating for users and/or may keep users motivated to continue working out from day to day.

Some embodiments may facilitate training across multiple exercise machines in any given video workout program, which may improve fitness, reduce injury, and/or improve overall performance of users.

In some embodiments, custom video workout programs and/or custom series of video workout programs may be available to all users or subscribers of an interactive fitness platform. Alternatively, custom video workout programs and/or custom series of video workout programs may be available to a subset of all users or subscribers of an interactive fitness platform, such as a subset of all users or subscribers that have a premium membership or subscription.

In some embodiments, the segments into which video workout programs are divided may be tagged or otherwise marked or identified with an indicator of an intensity of the workout within the segment. The intensity may be indicated in any manner and/or may be tied to one or more performance parameters of a user. For example, the intensity may be indicated in terms of heart rate zones (e.g., zone 1: 50-60% of maximum (max), zone 2: 60-70% of max, zone 3: 70-80% of max, zone 4: 80-90% of max, and zone 5: 90-100% of max) tied to a max heart of the user (which may be determined from user criteria, user data, or the like and/or from a max heart rate test), cycling power zones (active recovery: <55% of functional threshold power (FTP), endurance: 55-75% of FTP, tempo: 76-90% of FTP, lactate threshold: 91-105% of FTP, VO2 max: 106-120% of FTP, and anaerobic capacity: >121% of FTP) tied to an FTP of the user (which may be determined from user criteria, user data, or the like and/or from an FTP test), or other suitable indication of intensity. The remote server 112 or other server, system, or device may have one or more workout templates that specify a combination of two or more workout segments of given intensities for a particular type of workout or a workout with a given objective or objectives. In some embodiments, two or more segments may be spliced together to generate a custom video workout program based on user criteria and according to the workout templates and/or intensities of the segments. The user may select a desired workout template and/or a desired workout template may be inferred or determined, e.g., by the remote server 112, based on the user criteria or other information. Two or more segments selected based on the user criteria may be further selected and/or spliced together in a certain order according to the workout template. For example, if the workout template involves multiple intervals in heart rate zone 4 separated by recovery periods in heart rate zone 1, the intensity indications of the segments and the workout template may be used to determine which segments to use and in which order to combine the segments.

In some embodiments, custom series of video workout programs may be generated based on training plan templates. Each training plan template may have an objective, goal, or purpose. For example, different running training plan templates may be designed (e.g., by trainers) to train users to compete in running events of different distances (e.g., 5k, 10k, half marathon, full marathon, ultra marathon), different cycling training plan templates may be designed to train users to compete in cycling events of different types and/or distances (e.g., time trial, criterium, 100k, 100 mile, hilly, flat), different triathlon training plan templates may be designed to train users to compete in triathlon events of different distances (e.g., sprint, Olympic, half ironman, full ironman), and so on. Each training plan template may include a series of two or more workout templates that may optionally repeat on a periodic basis (e.g., weekly, monthly). For example, a training plan template may include a first workout template for workout day 1 (e.g., Monday), a second workout template for workout day 2 (e.g., Wednesday), a third workout template for workout day 3 (e.g., Friday), and a fourth workout template for workout day 4 (e.g., Saturday). Different video workout programs may follow different workout templates, may be modified on the fly to follow different workout templates, e.g., by modifying exercise machine control commands accordingly, and/or may be divided into segments and recombined as custom video workout programs that follow different workout templates. When a custom series of video workout programs is generated for a user, a training plan template may be selected, e.g., based on one or more fitness goals of the user to help the user achieve the one or more fitness goals. The custom series may be populated with video workout programs according to the workout templates of the training plan template. For example, video workout programs may be scheduled in the custom series by selecting, for any given day, a video workout program that follows the workout template in the corresponding day of the training plan template.

Methods herein have been discussed in the context of video workout programs but may be extended to other types of video programs, such as video mental health programs. Video mental health programs may be executed at or by exercise machines, immersive mental health devices, or the like. Example aspects of video mental health programs and immersive mental health devices are disclosed in U.S. Provisional Patent Application Ser. No. 63/200,903, filed Apr. 2, 2021, which is incorporated herein by reference in its entirety for all that it discloses. Accordingly, methods herein may include generating custom video mental health programs, generating custom series of video mental health programs, and/or generating custom series of video workout programs and video mental health programs.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

A. A method to generate a custom video workout program for a user, the method comprising:
dividing each of multiple video workout programs into multiple segments;
selecting a subset of the segments for inclusion in a custom video workout program for a user based on one or more user criteria specific to the user, the subset including at least a first segment from a first video workout program and a second segment from a second video workout program; and splicing the subset of segments together to generate the custom video workout program for the user.
   B. The method of claim A, wherein the one or more user criteria include at least one of:
interests of the user;
needs of the user;
exercise machines the user has access to;
scenery preferences of the user;
goals of the user;
educational content preferences of the user; or
trainer preferences of the user.
   C. The method of one of claims A or B, further comprising, prior to the selecting of the subset of segments, receiving user input that includes or indicates the one or more user criteria.
   D. The method of one of claims A-C, further comprising, prior to the selecting of the subset of segments, determining the one or more user criteria from an online fitness profile of the user.
   E. The method of one of claims A-D, wherein the selecting of the subset of segments is further based on at least one of an excitement parameter of each of the segments, a fun parameter of each of the segments, and/or an enjoyment parameter of each of the segments.
   F. The method of one of claims A-E, wherein:
the first video workout program is executable on a first type of exercise machine;
the second video workout program is executable on a second type of exercise machine that is different than the first type of exercise machine; and
the custom video workout program includes segments that are executable on different types of exercise machines, including the first segment that is executable on the first type of exercise machine and the second segment that is executable on the second type of exercise machine.
   G. The method of one of claims A-F, further comprising executing the custom video workout program at one or more exercise machines to enable the user to perform a custom workout.
   H. The method of claim G, wherein the selecting of the subset of segments includes dynamically selecting one or more subsequent segments of the subset after execution at the one or more exercise machines of at least a portion of a prior segment of the subset.
   I. The method of claim H, wherein the dynamically selecting includes dynamically selecting the second segment after execution of at least a portion of the first segment at the one or more exercise machines.
   J. The method of one of claims H or I, wherein:
the method further includes monitoring, at the one or more exercise machines, one or more performance parameters of the user during execution of the prior segment of the subset; and
the dynamically selecting of the one or more subsequent segments of the subset is further based on the one or more performance parameters of the user.
   K. The method of one of claims G-J, further comprising:
presenting one or more survey questions to the user after terminating execution of the custom video workout program at the one or more exercise machines;
receiving one or more responses to the one or more survey questions from the user; and
generating one or more subsequent custom video workout programs based on the one or more user criteria and the one or more responses to the one or more survey questions from the user.
   L. The method of one of claims A-K, further comprising, prior to the selecting of the subset of segments, determining the one or more user criteria, including:
presenting one or more survey questions to the user before, during, or after execution of a video workout program at an exercise machine; and
receiving one or more responses to the one or more survey questions from the user.
   M. A non-transitory computer-readable medium having computer-executable instructions stored thereon that are executable by a processing unit to perform or control performance of the method of one of claims A-L.
   N. A method to generate a series of custom video workout programs for a user, the method comprising:
determining one or more user criteria specific to a user;
identifying, based on the one or more user criteria, a subset of video workout programs in a video workout program library that match the user criteria; and
assembling the subset of video workout programs into a custom series of video workout programs for the user to be executed at one or more exercise machines for the user over a period of time.
   O. The method of claim N, wherein the determining the one or more user criteria comprises:
presenting one or more survey questions to the user before, during, or after execution of a video workout program at an exercise machine; and receiving one or more responses to the one or more survey questions from the user.
   P. The method of claim O, wherein each of the one or more survey questions relates to at least one of:
a level of engagement of the user with the video workout program;
a level of enjoyment of the user of the video workout program;
one or more types of exercise machines the user desires to use more for video workout programs in the future;
one or more types of exercise machines the user desires to use less for video workout programs in the future;
one or more fitness goals of the user; or
a typical amount of sleep of the user.
   Q. The method of one of claims O or P, wherein the presenting of the one or more survey questions to the user comprises presenting the one or more survey questions to the user aurally, visually, or both aurally and visually.
   R. The method of one of claims N-Q, wherein:
the method further comprises:
   providing access to the one or more user criteria to a trainer; and
   receiving input from the trainer; and
the identifying of the subset of video workout programs based on the one or more user criteria includes identifying the subset of video workout programs based on the input from the trainer.
   S. The method of one of claims N-R, further comprising presenting educational content to the user at an output device included in or communicatively coupled to a given exercise machine of the one or more exercise machines during execution of a given video workout program of the one or more video workout programs at the given exercise machine.
   T. The method of claim S, further comprising presenting, through the output device, one or more questions to the user that are related to the educational content.
   U. The method of claim T, wherein:
the method further includes monitoring, at the given exercise machine, a performance parameter of the user during execution of the given video workout program at the given exercise machine; and
a difficulty of the one or more questions presented to the user at any given time depends on at least one of the performance parameter at the given time or a difficulty of the given video workout program at the given time.
   V. The method of one of claims N-U, wherein:
the one or more user criteria include one or more fitness goals of the user; and
the subset of video workout programs that match the user criteria comprise video workout programs to assist the user in achieving the one or more fitness goals.
   W. A non-transitory computer-readable medium having computer-executable instructions stored thereon that are executable by a processing unit to perform or control performance of the method of one of claims N-V.
   X. A method to generate a custom video workout program, the method comprising:
recording a video of a trainer performing a workout;
dividing the video into multiple video segments;
generating multiple video workout programs from the video segments, each video workout program including a warmup, a different one of the video segments, and a cooldown;
receiving input to combine two or more of the video workout programs into the custom video workout program; and
in response to the input, splicing together video segments of the two or more of the video workout programs into the custom video workout program without any intervening warmups or cooldowns between a first one of the video segments of the two or more of the video workout programs and a last one of the video segments of the two or more of the video workout programs.
   Y. The method of claim X, wherein the splicing together of the video segments of the two or more of the video workout programs without any intervening warmups or cooldowns between the first and last video segments comprises splicing together the video segments of the two or more of the video workout programs while dropping all warmups and cooldowns between the first and the last video segments to form the custom video workout program.
   Z. The method of one of claims X or Y, wherein:
the video workout programs include first and second video workout programs;
the first video workout program includes a first video segment preceded by a first warmup and followed by a first cooldown;
the second video workout program includes a second video segment preceded by a second warmup and followed by a second cooldown; and
the input to combine the two or more of the video workout programs into the custom video workout program includes input to append the second video workout program to the first video workout program; and
   AA. The method of claim Z, the method further comprising:
executing the first video workout program at an exercise machine to enable a user to perform a portion of the workout; and
terminating execution of the first video workout program at or prior to the first cooldown and initiating execution of the second video workout program at an end of or following the second warmup to splice the first video segment and the second video segment together.
   BB. A non-transitory computer-readable medium having computer-executable instructions stored thereon that are executable by a processing unit to perform or control performance of the method of one of claims X-AA.

1. A method to generate a custom video workout program for a user, the method comprising:
dividing each of multiple video workout programs into multiple segments;
selecting a subset of the segments for inclusion in a custom video workout program for a user based on one or more user criteria specific to the user, the subset including at least a first segment from a first video workout program and a second segment from a second video workout program; and
splicing the subset of segments together to generate the custom video workout program for the user.

2. The method of claim 1, wherein the one or more user criteria include at least one of:
interests of the user;
needs of the user;
exercise machines the user has access to;
scenery preferences of the user;
goals of the user;
educational content preferences of the user; or
trainer preferences of the user.

3. The method of claim 1, wherein the selecting of the subset of segments is further based on at least one of an excitement parameter of each of the segments, a fun parameter of each of the segments, and/or an enjoyment parameter of each of the segments.

4. The method of claim 1, wherein:
the first video workout program is executable on a first type of exercise machine;
the second video workout program is executable on a second type of exercise machine that is different than the first type of exercise machine; and
the custom video workout program includes segments that are executable on different types of exercise machines, including the first segment that is executable on the first type of exercise machine and the second segment that is executable on the second type of exercise machine.

5. The method of claim 1, further comprising executing the custom video workout program at one or more exercise machines to enable the user to perform a custom workout.

6. The method of claim 5, wherein the selecting of the subset of segments includes dynamically selecting one or more subsequent segments of the subset after execution at the one or more exercise machines of at least a portion of a prior segment of the subset.

7. The method of claim 6, wherein the dynamically selecting includes dynamically selecting the second segment after execution of at least a portion of the first segment at the one or more exercise machines.

8. The method of claim 6, wherein:
the method further includes monitoring, at the one or more exercise machines, one or more performance parameters of the user during execution of the prior segment of the subset; and
the dynamically selecting of the one or more subsequent segments of the subset is further based on the one or more performance parameters of the user.

9. The method of claim 1, further comprising, prior to the selecting of the subset of segments, determining the one or more user criteria, including:
presenting one or more survey questions to the user before, during, or after execution of a video workout program at an exercise machine; and
receiving one or more responses to the one or more survey questions from the user.

10. A method to generate a custom series of video workout programs for a user, the method comprising:
determining one or more user criteria specific to a user;
identifying, based on the one or more user criteria, a subset of video workout programs in a video workout program library that match the user criteria; and
assembling the subset of video workout programs into a custom series of video workout programs for the user to be executed at one or more exercise machines for the user over a period of time.

11. The method of claim 10, wherein the determining of the one or more user criteria comprises:
presenting one or more survey questions to the user before, during, or after execution of a video workout program at an exercise machine; and
receiving one or more responses to the one or more survey questions from the user.

12. The method of claim 11, wherein each of the one or more survey questions relates to at least one of:
a level of engagement of the user with the video workout program;
a level of enjoyment of the user of the video workout program;
one or more types of exercise machines the user desires to use more for video workout programs in the future;
one or more types of exercise machines the user desires to use less for video workout programs in the future;
one or more fitness goals of the user; or
a typical amount of sleep of the user.

13. The method of claim 11, wherein the presenting of the one or more survey questions to the user comprises presenting the one or more survey questions to the user aurally, visually, or both aurally and visually.

14. The method of claim 10, wherein:
the method further comprises:
providing access to the one or more user criteria to a trainer; and
receiving input from the trainer; and
the identifying of the subset of video workout programs based on the one or more user criteria includes identifying the subset of video workout programs based on the input from the trainer.

15. The method of claim 10, further comprising presenting educational content to the user at an output device included in, or communicatively coupled to, a given exercise machine of the one or more exercise machines during execution of a given video workout program of the one or more video workout programs at the given exercise machine.

16. The method of claim 15, further comprising presenting, through the output device, one or more questions to the user that are related to the educational content.

17. The method of claim 16, wherein:
the method further includes monitoring, at the given exercise machine, a performance parameter of the user during execution of the given video workout program at the given exercise machine; and
a difficulty of the one or more questions presented to the user at any given time depends on at least one of the performance parameter at the given time or a difficulty of the given video workout program at the given time.

18. The method of claim 10, wherein:
the one or more user criteria include one or more fitness goals of the user; and
the subset of video workout programs that match the user criteria comprise video workout programs to assist the user in achieving the one or more fitness goals.

19. A method to generate a custom video workout program for a user, the method comprising:
recording a video of a trainer performing a workout;
dividing the video into multiple video segments;
generating multiple video workout programs from the video segments, each video workout program including a warmup, a different one of the video segments, and a cooldown;
receiving input to combine two or more of the video workout programs into the custom video workout program; and
in response to the input, splicing together video segments of the two or more of the video workout programs into the custom video workout program, without any intervening warmups or cooldowns between a first one of the video segments of the two or more of the video workout programs and a last one of the video segments of the two or more of the video workout programs.

20. The method of claim 19, wherein:
the video workout programs include first and second video workout programs;
the first video workout program includes a first video segment preceded by a first warmup and followed by a first cooldown;
the second video workout program includes a second video segment preceded by a second warmup and followed by a second cooldown;
the input to combine the two or more of the video workout programs into the custom video workout program includes input to append the second video workout program to the first video workout program; and
the method further comprises:
executing the first video workout program at an exercise machine to enable a user to perform a portion of the workout; and
terminating execution of the first video workout program at or prior to the first cooldown and initiating execution of the second video workout program at an end of or following the second warmup to splice the first video segment and the second video segment together.
